(19) United States
(12) Patent Application Publication
(10) Pub. No.: US 2026/0044093 A1
(43) Pub. Date: Feb. 12, 2026

(54) TONER

(71) Applicant: CANON KABUSHIKI KAISHA, Tokyo (JP)

(72) Inventors: TOHRU HIRAMATSU, Shizuoka (JP); SHOHEI SHIBAHARA, Shizuoka (JP); YUU SASANO, Shizuoka (JP); HIROKI KAGAWA, Shizuoka (JP)

(21) Appl. No.: 19/287,360

(22) Filed: Jul. 31, 2025

(30) Foreign Application Priority Data
Aug. 6, 2024 (JP) 2024-129977

(51) Int. Cl. G03G 9/087; G03G 9/08; G03G 9/093

(52) U.S. Cl. CPC G03G 9/08755; G03G 9/0827; G03G 9/09342; G03G 9/09385

(57) ABSTRACT

Provided is a toner that includes a toner particle containing a binder resin; and an external additive, wherein the binder resin contains a polyester resin A; when a content of the polyester resin A in the binder resin is taken as Wₚ (mass %), Wₚ is 50 mass % or more; when a content ratio of the monomer unit Uᵢₛₒ corresponding to isophthalic acid to all monomer units corresponding to polycarboxylic acids in the polyester resin A is taken as M_{IPA} (mol %), M_{IPA} is 40 mol % or more; the external additive contains inorganic fine powder; and the inorganic fine powder contains a silica fine particle having aluminum hydroxide on the surface thereof.

### BACKGROUND

### Field of the Technology

The present disclosure relates to a toner used in an electrophotographic image forming apparatus.

### Description of the Related Art

In an electrophotographic image forming apparatus, higher speed, smaller size, and longer life are required. For this reason, further improvements in various performances for a toner are required to achieve such requirements.

For example, in order to contribute to higher speed and smaller size of an electrophotographic apparatus, there is a need for a toner having excellent low-temperature fixability, that is, a toner with properties that can be fixed on paper sheets with a small amount of heat.

Also, in order to contribute to smaller size, a mono-component contact development system that does not contain a carrier particle that charges the toner is preferably used from the viewpoint of reducing the number of components. However, this developing system requires a highly durable toner that is less likely to be degraded because the toner and the photoreceptor continue to be in contact with each other for a long period of time.

Recently, due to the influence of climatic variations, the opportunity to use a toner in more-than-expected high-temperature and high-humidity environments has also increased. Since toner charging performance is reduced by the influence of moisture, a toner that can maintain the charged state on the toner surface and print with good image quality over a long period of time, even in high temperature and high humidity environments where the charging performance tends to drop, is required.

From these, demand for low-temperature fixability and durability of a toner, specifically for maintaining the charging performance in a high-temperature and high-humidity environment is increasing, but a toner with good low-temperature fixability tends to show low durability, and balancing these properties was sometimes a challenge.

For example, Japanese Patent Laid-Open No. 2019-049629 has proposed that using a toner, in which the binder resin contains a polyester resin being a polycondensate of a polycarboxylic acid and a polyhydric alcohol, and the polycarboxylic acid contains a predetermined amount of isophthalic acid, suppresses the occurrence of set off from a solid image to another image.

Meanwhile, Japanese Patent Laid-Open No. 2023-128532 has proposed a toner that contains an inorganic external additive in which the surface of an oxide of a metal element is covered with a hydroxide of a metal element and thus ensures the charge rising performance of the toner, suppresses toner scattering, and has charge stability.

Furthermore, Japanese Patent Laid-Open No. 2022-067499 has proposed a toner that contains a particle in which at least part of the surface of a silica particle with at least part of the surface coated with aluminum hydroxide is further coated with stearic acid and thus suppresses the occurrence of fogging after being left under a high-temperature and high-humidity environment.

### SUMMARY

As a result of the studies made by the inventors, the toner disclosed in Japanese Patent Laid-Open No. 2019-049629 showed a certain improvement in low-temperature fixability when the binder resin contains a polyester resin being a polycondensate of a polycarboxylic acid and a polyhydric alcohol, and the polycarboxylic acid contains a predetermined amount of isophthalic acid. However, when an image forming apparatus employing a mono-component developing system is used for a long period of time under a high temperature and high humidity environment, partial charging non-uniformity may occur in the developing unit due to a decrease in charging performance due to moisture effects. As a result, image density non-uniformity (fading) in the vertical direction may occur in an image with a high print percentage.

Furthermore, the toner disclosed in Japanese Patent Laid-Open No. 2023-128532 showed a certain improvement effect on long-term charge stability by containing an inorganic external additive in which the surface of an oxide of a metal element is covered with a hydroxide of a metal element. However, in an image forming apparatus employing a mono-component developing system in which the durability of a toner is more highly required, the charge rising performance under a high-temperature and high-humidity environment may be lowered, and image density non-uniformity due to insufficient charge may occur. As a result, density uniformity in a solid image with a high print percentage may be reduced.

Also, the toner disclosed in Japanese Patent Laid-Open No. 2022-067499 had an effect of suppressing the occurrence of fogging after being left under a high-temperature and high-humidity environment due to the presence of silica particle covered with aluminum hydroxide. However, the toner had low coverage uniformity between coated silica fine particle because the aluminum hydroxide treatment method is a vapor deposition treatment. For this reason, in the use of outputting an image at high frequency under a high-temperature and high-humidity environment, improvement in charge stability is insufficient, and in image printing at a high print percentage after long-term use and being left for a long period of time, image density non-uniformity in the longitudinal direction may occur. Further, there is room for improvement in low-temperature fixability.

The present disclosure provides a toner that has solved the above drawbacks. Specifically, the present disclosure provides a toner that has good low-temperature fixability, and charge rising performance and charge stability under a high-temperature and high-humidity environment, and can output an image with high-density uniformity, even in an image forming apparatus employing a mono-component developing system.

The present disclosure relates to a toner comprising: a toner particle comprising a binder resin; and an external additive, wherein the binder resin comprises a polyester resin A; when a content of the polyester resin A in the binder resin is taken as Wₚ (mass %), Wₚ is 50 mass % or more; the polyester resin A is a copolymer of a polycarboxylic acid and a polyol; the polycarboxylic acid comprises an isophthalic acid; when a content ratio of a monomer unit Uᵢₛₒ corresponding to the isophthalic acid with respect to all monomer units corresponding to the polycarboxylic acid in the polyester resin A is taken as M_{IPA} (mol %), M_{IPA} is 40 mol % or more; the external additive comprises an inorganic fine powder; and the inorganic fine powder comprises a silica fine particle having aluminum hydroxide on a surface thereof.

The present disclosure can provide a toner that has good low-temperature fixability and good charge rising performance and charge stability in a high-temperature and high-humidity environment. Further, the present disclosure provides a toner that can output an image with high density uniformity, even in an image forming apparatus employing a mono-component contact development system.

Features of the present disclosure will become apparent from the following description of embodiments with reference to the attached drawings. The following description of embodiments is described by way of example.

### DESCRIPTION OF THE EMBODIMENTS

In the present disclosure, the expression “from XX to YY” or “XX to YY” representing a numerical range means a numerical range including a lower limit and an upper limit, which are endpoints, unless otherwise specified. Also, when numerical ranges are described in a stepwise manner, the upper and lower limits of each of the numerical ranges can be arbitrarily combined. In addition, in the present disclosure, the description such as “at least one selected from the group consisting of XX, YY and ZZ” means any of XX, YY, and ZZ, a combination of XX and YY, a combination of XX and ZZ, a combination of YY and ZZ, or a combination of XX, YY, and ZZ. In the case where XX is a group, a plurality of XX may be selected from XX, and the same is true for YY and ZZ.

In the present disclosure, the term (meth)acrylate means methacrylate and/or acrylate.

In the present disclosure, the term “monomer unit” refers to a reacted form of a monomer material in a polymer. For example, a portion between ester bonds in a polyester is taken as one unit. Also, the one unit corresponds to one molecule in calculations of mol %.

As described above, as a means for improving the low-temperature fixability of the toner, it is effective to make the binder resin contain a polyester resin using a polycarboxylic acid containing a predetermined amount of isophthalic acid in the toner particle.

However, in an image forming apparatus employing a mono-component contact development system, in a severe use in which printing is performed at high frequency in a high-temperature and high-humidity environment, the toner and the photoreceptor continue to be in contact with each other for a long period of time. Therefore, toner degradation due to the embedding or release of the external additive is likely to occur as a result of toner rubbing.

Furthermore, the studies made by the inventors have revealed that toner degradation due to the embedding of external additives is likely to occur, particularly under high-temperature and high-humidity environments, and in addition, the charge is eliminated from the charged site on the toner surface due to moisture in the environment, whereby the charging performance of the toner is likely to decrease.

Therefore, in an image forming apparatus employing a mono-component contact development system, when a high print percentage image is output under a high-temperature and high-humidity environment and then left for a certain period of time and used again, the state where the external additive is attached to the toner particle changes. In addition, it has been found that the image density non-uniformity of the image is caused by a decrease in the charging performance of the toner.

The results of detailed studies made by the present inventors have revealed the following: When the toner particle contains a polyester resin containing a monomer unit corresponding to isophthalic acid, as in the case of the toner described in Japanese Patent Laid-Open No. 2019-049629, charge rising performance under a high temperature and high humidity environment and uniformity of image density in long-term use were less likely to be maintained as compared with the case of using a polyester resin containing only a monomer unit corresponding to terephthalic acid as a polycarboxylic acid.

Although the reason for this is not clear, the monomer unit corresponding to isophthalic acid has microscopically charged regions, that is, microscopically negative regions, because the orientation of the oxygen atoms of a carbonyl group bonded to the benzene ring is easily aligned. If the microscopically negative regions are present on the toner particle surface, charge is neutralized by attracting polar groups of water molecules in the environment. It is thus inferred that the charging performance is likely to decrease when left under a high temperature and high humidity environment.

Also, it is inferred that the surface of a silica fine particle common as an external additive also causes a similar reduction in charging performance due to the adsorption of water molecules to SiOH groups, which are charging sites, under high-temperature and high-humidity environments. Therefore, charge rising performance and uniformity of image density in long-term use are not improved only by externally adding a silica fine particle.

Accordingly, the present inventors have made intensive studies on a means of suppressing a decrease in the charging performance under a high-temperature and high-humidity environment in a toner particle containing, as a main binder resin component, a polyester resin containing a predetermined amount of a monomer unit corresponding to isophthalic acid. As a result, the present inventors have found that the low-temperature fixability of a toner and the charge rising performance and charge stability of the toner under a high-temperature and high-humidity environment can be all achieved by incorporating inorganic fine powder containing a silica fine particle having aluminum hydroxide on the surface into an external additive, and the present disclosure has been completed.

That is, the present disclosure relates to a toner comprising: a toner particle comprising a binder resin; and an external additive, wherein the binder resin comprises a polyester resin A; when a content of the polyester resin A in the binder resin is taken as Wₚ (mass %), Wₚ is 50 mass % or more; the polyester resin A is a copolymer of a polycarboxylic acid and a polyol; the polycarboxylic acid comprises an isophthalic acid; when a content ratio of a monomer unit Uᵢₛₒ corresponding to the isophthalic acid with respect to all monomer units corresponding to the polycarboxylic acid in the polyester resin A is taken as M_{IPA} (mol %), M_{IPA} is 40 mol % or more; the external additive comprises an inorganic fine powder; and the inorganic fine powder comprises a silica fine particle having aluminum hydroxide on a surface thereof.

With the above-described configuration, it is considered that the following mechanism will improve the charge rising performance and the charge stability of the toner under a high-temperature and high-humidity environment.

The inorganic fine powder contains a silica fine particle having aluminum hydroxide on the surface thereof. Aluminum hydroxide has a more hydrophilic structure compared to silica. Therefore, on the surface of the inorganic fine powder, moisture is likely to be adsorbed to the AlOH groups of the aluminum hydroxide.

It is believed that when inorganic fine powder is present on the surface of a toner particle containing a binder resin having a monomer unit corresponding to isophthalic acid, water molecules are shared between AlOHs on the surface of the inorganic fine powder and carboxyl groups in isophthalic acid. Since aluminum hydroxide is a substance having a slightly low volume resistance, a microscopic conductive path is formed by sharing a plurality of water molecules with the toner particle surface. It is believed that this conductive path suppresses local charge loss and induces the charged state of the silica fine particle as the core to produce an interaction that amplifies negative charging performance, and as a result, an effect of maintaining and improving the charging performance is manifested.

In addition, it is inferred that since electrostatic attachment force is generated between an AlOH group on the surface of the inorganic fine powder and the COO group of isophthalic acid by the intervention of water molecules, the inorganic fine powder is hardly transferred from the toner particle even in long-term durability use, and long-term charge stability is improved.

In contrast, if a fine particle in which silica fine particle is covered with aluminum oxide (Al₂O₃) or a fine particle obtained by forming a complex of aluminum oxide and silica are externally added, the effect of suppressing charge drop due to moisture in the above environment is not exhibited because the aluminum oxide has a high insulation property.

In addition, when an aluminum hydroxide fine particle is used as an external additive, charging performance cannot be impaired because aluminum hydroxide has low powder resistance.

As described above, it is necessary that the inorganic fine powder of the present disclosure contains a silica fine particle having aluminum hydroxide on the surface thereof. The presence of the aluminum hydroxide portion exhibits a moderate conductive effect without inhibiting the electrostatic charging characteristics of the silica fine particle, and even in a high-temperature and high-humidity environment where a charge is likely to drop, the interaction between the AlOH groups on the surface of the inorganic fine powder and the monomer unit corresponding to isophthalic acid and water molecules in the environment suppresses charge drop, and the toner exhibits less fogging on a non-image part even in long-term durability use, which is thus preferable.

The toner contains a toner particle contains a binder resin. The binder resin contains a polyester resin A.

When the content of the polyester resin A in the binder resin is taken as Wₚ (mass %), Wₚ is 50 mass % or more. The polyester resin A is a copolymer of a polycarboxylic acid and a polyol, and the polycarboxylic acid contains an isophthalic acid. When the content ratio of the monomer unit Uᵢₛₒ corresponding to isophthalic acid with respect to all monomer units corresponding to polycarboxylic acid in the polyester resin A is taken as M_{IPA} (mol %), M_{IPA} is 40 mol % or more.

Thus, not only the fixing performance of the half-tone image is good, but also the density uniformity of the solid image is good even when a durability test is performed in a double-sided printing mode in a mono-component contact development system.

### Binder Resin

The toner particle contains a binder resin. The content ratio of the binder resin in the toner particle is not particularly limited, but may be, for example, 80 to 99 parts by mass or 82 to 95 parts by mass.

The content Wₚ (mass %) of the polyester resin A in the binder resin needs to be 50 mass % or more, as described above. Further, from the viewpoint that contamination of a charging member can be suppressed even in long-term durability use under a low-temperature and low-humidity environment, half-tone image density non-uniformity can be reduced, and low-temperature fixability can also be good, the content is preferably 70 mass % or more, and more preferably 80 mass % or more. The upper limit is not particularly limited, and may be 50 to 100 mass %, 70 to 100 mass %, 80 to 100 mass %, or 80 to 95 mass %. The method of measuring Wₚ will be described later.

The binder resin is not particularly limited, and examples thereof may include a styrene acrylic resin, an epoxy resin, a polyester resin, a polyurethane resin, a polyamide resin, a cellulose resin, a polyether resin, a mixed resin or a composite resin thereof, and the like. The binder resin preferably contains at least one selected from the group consisting of a polyester resin and a styrene acrylic resin.

### Polyester Resin A

The polyester resin A is a copolymer of a polycarboxylic acid and a polyol. The polycarboxylic acid includes isophthalic acid. When the content ratio of a monomer unit Uᵢₛₒ corresponding to isophthalic acid with respect to all monomer units corresponding to polycarboxylic acid in the polyester resin A is taken as M_{IPA}, M_{IPA} needs to be 40 mol % or more, and is preferably 60 mol % or more, and still more preferably 90 mol % or more. The upper limit is not particularly limited, and may be 40 to 100 mol %, 60 to 100 mol %, or 90 to 100 mol %. The method of measuring M_{IPA} will be described later.

The polyester resin A is preferably an amorphous polyester. The amorphous polyester has excellent low-temperature fixability and has a large number of polar groups, so that the dispersion of the pigment and the charge control agent is improved, and good coloring and charging characteristics are exhibited.

The content ratio of the monomer unit corresponding to isophthalic acid to all monomer units corresponding to polycarboxylic acid of the polyester resin A is preferably 40 to 100 mass %, more preferably 60 to 100 mass %, and still more preferably 90 to 100 mass %.

Any polyester resin having a monomer unit corresponding to isophthalic acid may be used as the polyester resin A, but may include, for example, the following.

The polyester resin A is obtained by selecting a combination of suitable compounds among polycarboxylic acids, polyols, hydroxycarboxylic acids, and the like and synthesizing the polyester resin from the selected compounds using a known method such as a transesterification method or a polycondensation method. Preferably, the polyester resin contains a condensation-polymerized polymer of a dicarboxylic acid and a diol.

The polycarboxylic acid is a compound containing at least two carboxy groups in one molecule. As described above, the polycarboxylic acid contains isophthalic acid, and may contain other polycarboxylic acids.

Among polycarboxylic acids, a dicarboxylic acid is a compound that contains two carboxy groups in one molecule and is preferably used.

Examples of dicarboxylic acids may include oxalic acid, succinic acid, glutaric acid, maleic acid, adipic acid, β-methyladipic acid, azelaic acid, sebacic acid, nonanedicarboxylic acid, decanedicarboxylic acid, undecanedicarboxylic acid, dodecanedicarboxylic acid, fumaric acid, citraconic acid, diglycolic acid, cyclohexa-3,5-diene-1,2-carboxylic acid, hexahydroterephthalic acid, malonic acid, pimelic acid, suberic acid, phthalic acid, terephthalic acid, tetrachlorophthalic acid, chlorophthalic acid, nitrophthalic acid, p-carboxyphenylacetic acid, p-phenylenediacetic acid, m-phenylenediacetic acid, o-phenylenediacetic acid, diphenylacetic acid, diphenyl-p,p′-dicarboxylic acid, naphthalene-1,4-dicarboxylic acid, naphthalene-1,5-dicarboxylic acid, naphthalene-2,6-dicarboxylic acid, anthracenedicarboxylic acid, and cyclohexanedicarboxylic acid. As described above, in the polyester resin A of the present disclosure, the polycarboxylic acid includes isophthalic acid.

Examples of polycarboxylic acids other than dicarboxylic acids may include trimellitic acid, trimesic acid, pyromellitic acid, naphthalenetricarboxylic acid, naphthalenetetracarboxylic acid, pyrenetricarboxylic acid, pyrenetetracarboxylic acid, itaconic acid, glutaconic acid, n-dodecylsuccinic acid, n-dodecenylsuccinic acid, isododecylsuccinic acid, isododecenylsuccinic acid, n-octylsuccinic acid, n-octenylsuccinic acid, and the like. These compounds may be used alone or in combination of at least two kinds thereof. Among others, trimellitic acid is preferable.

The polyol is a compound containing at least two hydroxyl groups in one molecule. Among them, a diol is a compound that contains two hydroxyl groups in one molecule and is preferably used.

Specific examples thereof may include ethylene glycol, diethylene glycol, triethylene glycol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,14-eicosanedecanediol, dipropylene glycol, polyethylene glycol, polypropylene glycol, polytetramethylene ether glycol, 1,4-cyclohexanediol, 1,4-cyclohexanedimethanol, 1,4-butenediol, neopentyl glycol, polytetramethylene glycol, hydrogenated bisphenol A, bisphenol A, bisphenol F, bisphenol S, an alkylene oxide (ethylene oxide, propylene oxide, butylene oxide, or the like) adduct of the bisphenol mentioned above, and the like.

The polyol is preferably at least one selected from the group consisting of alkylene glycols having 2 to 12 carbon atoms and alkylene oxide adducts of bisphenols, and an alkylene oxide adduct of a bisphenol and an alkylene glycol having 2 to 12 carbon atoms are particularly preferable. Examples of bisphenol A alkylene oxide adducts may include compounds represented by the following Formula (A).

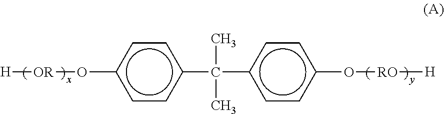

(In Formula (A), R is each independently at least one selected from the group consisting of an ethylene group and a propylene group, x and y are each an integer of 0 or greater, and the average value of x+y is from 0 to 10.)

The bisphenol A alkylene oxide adduct is preferably a bisphenol A propylene oxide adduct and/or a bisphenol A ethylene oxide adduct, and more preferably a bisphenol A propylene oxide adduct and a bisphenol A ethylene oxide adduct. A propylene oxide adduct is also preferable. In addition, the average of x+y is preferably from 1 to 5.

Examples of polyols having a functionality of three or more may include glycerol, trimethylolethane, trimethylolpropane, pentaerythritol, hexamethylolmelamine, hexaethylolmelamine, tetramethylolbenzoguanamine, tetraethylolbenzoguanamine, sorbitol, trisphenol PA, phenol novolac, cresol novolac, and an alkylene oxide adduct of polyphenols having a functionality of three or more mentioned above. These compounds may be used alone or in combination of at least two kinds thereof.

As described above, the polyester resin A is a copolymer of a polycarboxylic acid and a polyol. When the polyol includes a bisphenol A ethylene oxide adduct and a bisphenol A propylene oxide adduct, the sum of the content ratio of a monomer unit U_{EO} corresponding to the bisphenol A ethylene oxide adduct and the content ratio of a monomer unit U_{PO} corresponding to the bisphenol A propylene oxide adduct with respect to all monomer units corresponding to polyol in the polyester resin A is preferably 90 mol % or more and more preferably 95 mol % or more. The upper limit thereof is not particularly limited, but may be 90 to 100 mol % or 95 to 100 mol %.

A bisphenol A ethylene oxide adduct and a bisphenol A propylene oxide adduct are characterized in that they are easily plasticized by waxes and crystalline polyesters contained in the toner particle when heated and melted during fixation. Therefore, with the content within the above range, the binder resin is plasticized and becomes more likely to be infiltrated into paper fibers when heated and melted during fixation. Therefore, the adhesion of the toner to the paper is further increased, and the image becomes scratch-resistant, which is thus preferable.

The sum of the content ratio of the monomer unit U_{EO} corresponding to the bisphenol A ethylene oxide adduct and the content ratio of the monomer unit U_{PO} corresponding to the bisphenol A propylene oxide adduct with respect to all monomer units corresponding to polyol in the polyester resin A is preferably 96 to 100 mass % and more preferably 98 to 100 mass %.

When the polyol includes a bisphenol A ethylene oxide adduct and a bisphenol A propylene oxide adduct, the sum of the content ratio of the monomer unit U_{EO} corresponding to the bisphenol A ethylene oxide adduct and the content ratio of the monomer unit U_{PO} corresponding to the bisphenol A propylene oxide adduct with respect to all monomer units corresponding to polyol in the polyester resin A is taken as 100 parts by mole, the content ratio of the monomer unit U_{EO} is preferably 15 to 40 parts by mole.

U_{PO} is a bisphenol A unit with propylene oxide added thereto, which has a higher number of carbon atoms than U_{EO} and has a branched structure. Thus, U_{PO} has features that are more hydrophobic and shows smaller intermolecular forces than U_{EO}. Conversely, U_{EO} has features that are less hydrophobic and shows higher intermolecular forces than U_{PO}.

With the content ratio of U_{EO} of 15 parts by mole or more, the intermolecular force of the polyester resin A increases, and, therefore, the deformation of the polyester resin A tends to be suppressed under a high-temperature and high-humidity environment. With the content ratio of U_{EO} of 40 parts by mole or less, the hydrophobicity of the polyester resin A increases, and, therefore, the moisture adsorption amount of the polyester resin A is less likely to be excessively high under a high-temperature and high-humidity environment. With the content ratio of U_{EO} of 15 to 40 parts by mole, the durability of the toner under a high-temperature and high-humidity environment is good by these actions, and the fogging to a non-image part can be suppressed, which is thus preferable. The content ratio of U_{EO} is more preferably 20 to 35 parts by mole and still more preferably 25 to 30 parts by mole. The method of measuring the content ratio of U_{EO} will be described later.

When the sum of the content ratio of the monomer unit U_{EO} corresponding to the bisphenol A ethylene oxide adduct and the content ratio of a monomer unit U_{PO} corresponding to the bisphenol A propylene oxide adduct with respect to all monomer units corresponding to polyol in the polyester resin A is taken as 100 parts by mass, the content ratio of the monomer unit U_{EO} is preferably 14 to 39 parts by mass, preferably 19 to 34 parts by mass, and still more preferably 24 to 32 parts by mass.

When a number average molecular weight is taken as Mₙ and the weight-average molecular weight is taken as M_{w} when the tetrahydrofuran-soluble matter of the polyester resin A is measured using gel permeation chromatography (GPC), Mₙ is preferably 3000 to 10000.

With the number average molecular weight (Mₙ) of 3,000 or more, the durability of the toner under a high-temperature and high-humidity environment is good, and the fogging to the non-image part is easily suppressed. In contrast, with the number-average molecular weight (Mₙ) of 10,000 or less, the melting flowability of the binder resin during fixation increases and the binder resin is easily infiltrated into the fibers of the paper, and, therefore, the adhesion to the paper increases, and the scratch resistance of the image becomes good, which is thus preferable.

The number average molecular weight (Mₙ) is preferably 4000 to 8000, more preferably 4000 to 7000, and still more preferably 4000 to 5000.

M_{w}/Mₙ is preferably 2.5 or more. M_{w}/Mₙ of 2.5 or more means that the molecular weight distribution of the polyester resin A is sufficiently wide. This causes sufficient entanglement between molecular chains of the polyester resin A, and the toner particle is thus likely to have sufficient hardness even under a high-temperature and high-humidity environment. As a result, the durability of the toner is better, and the fogging to the non-image part can be suppressed, which is thus preferable. M_{w}/Mₙ is more preferably 3.0 or more, still more preferably 4.0 or more, and particularly preferably 5.0 or more. The upper limit is not particularly limited, but may be 2.5 to 12.0, 3.0 to 11.0, 4.0 to 10.0, and 5.0 to 10.0.

The method of measuring Mₙ and M_{w}/Mₙ will be described later.

The acid value of the polyester resin A is preferably 4.0 to 10.0 mgKOH/g and more preferably 5.0 to 8.0 mgKOH/g.

### Release Agent

A known release agent can be used for the toner. For example, it is preferable that the toner particle contains a release agent.

Specific examples thereof may include a petroleum wax and a derivative thereof, such as paraffin wax, microcrystalline wax, or petrolatum; montan wax and a derivative thereof; a hydrocarbon wax obtained through a Fischer-Tropsch method and a derivative thereof; a polyolefin wax and a derivative thereof represented by polyethylene; a natural wax and a derivative thereof represented by carnuba wax and candelilla wax; an ester wax; and the like. The derivatives also include oxides, block copolymers with a vinyl monomer, and graft-modified products.

Examples may also include an alcohol such as a higher aliphatic alcohol; a fatty acid such as stearic acid and palmitic acid, or an acid amide, an ester, and a ketone thereof; hydrogenated castor oil and a derivative thereof, a plant wax, and an animal wax. These compounds may be used alone or in combination.

Among these, when a polyolefin wax, a hydrocarbon wax obtained through a Fischer-Tropsch method, or a petroleum wax is used, the developing performance and the transferability tend to be improved, which is thus preferable. That is, the wax preferably includes at least one selected from the group consisting of a polyolefin wax, a hydrocarbon wax, a petroleum-based wax, and an ester wax, and preferably contains an ester wax. When the ester wax is included, low-temperature fixability is more likely to be improved. Further, from the viewpoint of balance with durability, it is more preferable to use an ester wax and a hydrocarbon wax in combination. It should be noted that an antioxidant may be added to these waxes within a range that does not affect the effect of the toner.

As described above, it is preferable that the toner particle contains an ester wax. Ester waxes are not particularly limited, and examples thereof may include an ester of a monohydric alcohol and an aliphatic carboxylic acid, such as behenyl behenate, stearyl stearate, and palmityl palmitate, or an ester of a monocarboxylic acid and an aliphatic alcohol; an ester of a dihydric alcohol and an aliphatic carboxylic acid, such as ethylene glycol distearate, dibehenyl sebacate, and hexanediol dibehenate, or an ester of a dicarboxylic acid and an aliphatic alcohol; an ester of a trihydric alcohol and an aliphatic carboxylic acid, such as glycerin tribehenate, or an ester of a tricarboxylic acid and an aliphatic alcohol; an ester of a tetrahydric alcohol and an aliphatic carboxylic acid, such as pentaerythritol tetrastearate and pentaerythritol tetrapalmitate, or an ester of a tetracarboxylic acid and an aliphatic alcohol; an ester of a hexahydric alcohol and an aliphatic carboxylic acid, such as dipentaerythritol hexastearate and dipentaerythritol hexapalmitate, or an ester of a hexacarboxylic acid and an aliphatic alcohol; an ester of a polyhydric alcohol and an aliphatic carboxylic acid, such as polyglycerol behenate, or an ester of a polycarboxylic acid and an aliphatic alcohol; and a natural ester wax, such as carnauba wax and rice wax. These may be used alone or in combination.

Further, from the viewpoint of phase separation property to the binder resin or crystallization temperature, higher fatty acid esters, such as behenyl behenate and dibehenyl sebacate, can be suitably exemplified. Specifically, behenyl behenate is preferable.

The content of the release agent is preferably from 1.0 to 30.0 parts by mass with respect to 100.0 parts by mass of the binder resin.

The melting point of the release agent is preferably from 30° C. to 120° C. and more preferably from 60° C. to 100° C. By using a release agent exhibiting the above-described thermal characteristics, the releasing effect is efficiently developed, and a wider fixing region is secured.

### Crystalline Polyester

The binder resin preferably contains a crystalline polyester. The crystalline polyester is preferably a condensation-polymerized polymer of monomers containing an aliphatic diol and/or an aliphatic dicarboxylic acid. It should be noted that a crystalline polyester refers to a polyester having a clear melting point as measured using a differential scanning calorimeter (DSC).

The crystalline polyester preferably contains a monomer unit corresponding to an aliphatic diol having 2 to 12 (more preferably 6 to 12) carbon atoms and/or a monomer unit corresponding to an aliphatic dicarboxylic acid having 2 to 12 (more preferably 6 to 12) carbon atoms.

The crystalline polyester having such a structure ensures good dispersibility of the crystalline polyester in the toner particle and further suppresses the non-uniformity of wet spreading between the toner particles during fixation. Therefore, the low-temperature fixability of a half-tone image and a line image is likely to be good.

Examples of aliphatic diols having 2 to 12 carbon atoms may include the following compounds:

1,2-ethandiol, 1,3-propanediol, 1,4-butanediol, 1,5-pentanediol, 1,6-hexanediol, 1,7-heptandiol, 1,8-octandiol, 1,9-nonandiol, 1,10-decanediol, 1,11-undecanediol, and 1,12-dodecanediol. Among them, at least one selected from the group consisting of 1,9-nonandiol and 1,12-dodecanediol is preferable.

Aliphatic diol having a double bond may also be used. Examples of aliphatic diols having a double bond may include the following compounds:

2-butene-1,4-diol, 3-hexene-1,6-diol, and 4-octene-1,8-diol.

Examples of aliphatic dicarboxylic acids having 2 to 12 carbon atoms include the following compounds:
oxalic acid, malonic acid, succinic acid, glutaric acid, adipic acid, pimelinic acid, suberic acid, azelaic acid, sebacic acid, 1,9-nonanedicarboxylic acid, 1,10-decanedicarboxylic acid, 1,11-undecanedicarboxylic acid, and 1,12-dodecanedicarboxylic acid. Lower alkyl esters and acid anhydrides of these aliphatic dicarboxylic acids may also be used.

Among them, sebacic acid, adipic acid, 1,10-decanedicarboxylic acid, and 1,12-dodecanedicarboxylic acid, and lower alkyl esters and acid anhydrides thereof are preferable. Sebacic acid, adipic acid, and 1,12-dodecanedicarboxylic acid, and lower alkyl esters and acid anhydrides thereof are more preferable. These may be used alone or two or more thereof may be mixed and used.

Aromatic dicarboxylic acids may also be used. Examples of aromatic dicarboxylic acids may include the following compounds: terephthalic acid, isophthalic acid, 2,6-naphthalenedicarboxylic acid, and 4,4′-biphenyldicarboxylic acid. Among these, terephthalic acid is preferable in view of ready availability and easiness of forming a low melting point polymer.

A dicarboxylic acid having a double bond may also be used. A dicarboxylic acid having a double bond may be suitably used to suppress hot offset during fixation in that the double bond can be utilized to cross-link the entire resin.

Examples of such dicarboxylic acids may include fumaric acid, maleic acid, 3-hexenedioic acid, and 3-octenedioic acid. Examples thereof may also include these lower alkyl esters and acid anhydrides thereof. Among them, at least one selected from the group consisting of fumaric acid and maleic acid is preferable.

The method of producing a crystalline polyester is not particularly limited, and can be produced by a general polymerization process of polyesters in which a dicarboxylic acid component and a diol component are reacted. For example, a crystalline polyester can be produced by using a direct polycondensation method or a transesterification method depending on the type of monomer.

The peak temperature of the maximum endothermic peak as measured using a differential scanning calorimeter (DSC) of the crystalline polyester is preferably from 50.0° C. to 100.0° C. and more preferably 60.0° C. to 90.0° C. from the viewpoint of low-temperature fixability.

The acid value of the crystalline polyester is preferably 0.5 to 8.0 mg KOH/g. The acid value is more preferably 1.0 to 5.0 mgKOH/g and still more preferably 1.5 to 4.0 mgKOH/g.

The weight-average molecular weight M_{w1} of the crystalline polyester is preferably 4,000 to 40,000 and more preferably 10,000 to 30,000. Within this range, the degree of crystallinity of the crystalline polyester is kept high, and the plastic effect of the crystalline polyester can be obtained quickly in the fixing step. When M_{w1} is 40,000 or less, the solubility of the crystalline polyester itself is less likely to decrease, the productivity of the toner is improved, and the effect of improving the low-temperature fixability is easily obtained.

In contrast, when M_{w1} is 4,000 or more, the crystalline polyester hardly outmigrate from the surface of the toner, and the charge stability of the toner is improved.

Also, the value of the ratio (M_{w1}/Mₙ₁) of the weight-average molecular weight M_{w1} to the number average molecular weight Mₙ₁ of the crystalline polyester is not particularly limited and preferably 1.5 to 2.5.

It is preferable that the content of the crystalline polyester in the binder resin is 3.0 to 15.0 mass % from the viewpoint of the balance between low-temperature fixability and durability, and more preferably 5.0 to 13.0 mass %.

### Inorganic Fine Powder

The toner contains an external additive. The external additive contains inorganic fine powder. The inorganic fine powder contains a silica fine particle having aluminum hydroxide on the surface thereof. That is, aluminum hydroxide covers at least a portion of the surface of the silica fine particle. At this time, the silica fine particle acts as a substrate.

The silica fine particle preferably has a thin film layer having an aluminum hydroxide structure on at least a part of the surface of the silica fine particle.

By coating at least a part of the surface of the silica fine particle with aluminum hydroxide, the volume resistance of silica can be reduced, and charge attenuation due to moisture can be suppressed.

The presence of aluminum hydroxide on the surface of the silica particle can be confirmed by energy-dispersive X-ray spectroscopy mapping (TEM-EDS mapping) and X-ray diffraction patterns (XRD) of a transmission electron microscope.

The TEM-EDS mapping can confirm the presence of the aluminum element on the surface of a silica fine particle. Also, in XRD, it is possible to qualitatively determine whether aluminum is an oxide or hydroxide. If aluminum is present as aluminum oxide, a clear peak depending on the crystal system appears. Meanwhile, if it is present as aluminum hydroxide, no clear peak is detected in the XRD pattern. Methods of measuring the TEM-EDS mapping and the XRD will be described below.

The amount of the aluminum hydroxide to be treated is preferably determined in terms of aluminum oxide Al₂O₃, and specifically, 1 to 30 mass % is preferable in terms of aluminum oxide based on the mass of the silica particle.

If the amount of aluminum hydroxide to be treated is less than 1% by mass in terms of aluminum oxide, the amount of aluminum hydroxide covering the surface of the silica fine particle is likely to be insufficient. For this reason, the charging performance may not be sufficiently improved under a high-temperature and high-humidity environment. Meanwhile, if the amount is greater than 30% by mass, the high charging performance of the silica fine particle may be impaired.

Although details will be described later, the following methods can be mentioned as methods of coating aluminum hydroxide on a silica fine particle. First, a water-soluble salt of aluminum is prepared, and an aqueous solution is prepared using the water-soluble salt and water. After the obtained aqueous solution is added to the silica fine particle, an alkaline substance such as an aqueous sodium hydroxide solution is added to cause hydrolysis of the water-soluble salt of aluminum, thereby covering the silica particle as aluminum hydroxide.

Examples of water-soluble salts of aluminum may include chloride, bromide, sulfate, nitrate, acetate, carbonate, and hydrogencarbonate of aluminum, and the like, and aluminum chloride is preferable.

The coverage amount of aluminum hydroxide can be changed by controlling the conditions (pH, temperature at warming, or the like) during production.

The coverage ratio of aluminum (Al) element relative to the inorganic fine powder, obtained from an element mapping image of aluminum and silicon measured by the STEM-EDS mapping of the inorganic fine powder, is preferably 40% to 90% by area. When the coverage ratio of the Al element relative to the inorganic fine powder is 40% by area or more, the interaction effect of the inorganic fine powder and water molecules under a high-temperature and high-humidity environment appropriately occurs. This makes it easier to suppress charge degradation and further improves charge rising performance and charge stability. In contrast, with the coverage ratio of the Al element relative to the inorganic fine powder of 90% by area or less, the silica fine particle exhibits good charging characteristics while maintaining good negative charging characteristics of the silica fine particle, which is thus preferable. The coverage ratio of the Al element relative to the inorganic fine powder is more preferably 45% to 85% by area and more preferably 50% to 80% by area. The coverage ratio of the Al element relative to the inorganic fine powder can be varied by controlling the conditions (pH, temperature at warming, etc.) during the production.

A method of calculating the coverage ratio of the Al element relative to the inorganic fine powder will be described later.

When the value (Al/Si) of a ratio of the number of atoms of Al to Si measured by X-ray photoelectric spectrophotometry (XPS) of the inorganic fine powder is taken as X₁, and the value (Al/Si) of the mass ratio of Al to Si measured by fluorescent X-ray analysis (XRF) of the inorganic fine powder is taken as X₂, it is preferable that the X₁ and the X₂ satisfy Formula (1).

$$0.8 \leq {X}_{1} / {X}_{2} \leq 2 \text{.00} \qquad ( 1 )$$

XPS can selectively and quantitatively measure elements present on the surface within several nanometers of inorganic fine powder. Also, XRF allows quantitative measurement of elements contained in the entire inorganic fine powders. That is, the XRF measurement results indicate the content of elements contained in the inorganic fine powder.

Accordingly, the value of X₁/X₂ of 0.80 or more indicates that many Al elements corresponding to aluminum hydroxide are present near the surface of the inorganic fine powder. That is, it indicates that the covered state with aluminum hydroxide is good. As a result, moisture-mediated interactions between the inorganic fine powder surface and the monomer unit corresponding to isophthalic acid are effectively developed, and charge rising performance in high-temperature and high-humidity environments is further improved.

In contrast, the value of X₁/X₂ of 2.00 or less means that aluminum hydroxide on the surface of the inorganic fine powder is present as a thin layer. As a result, aluminum hydroxide is less likely to inhibit good charging performance of a silica fine particle, and is likely to improve charge rising performance and charging maintenance rate in high-temperature and high-humidity environments.

The value of X₁/X₂ is preferably from 0.85 to 1.95, more preferably from 0.90 to 1.85, and still more preferably from 1.00 to 1.50.

The value of X₁/X₂ can be adjusted by adjusting X₁ and X₂ in the manner described below. The value of X₁/X₂ can be calculated from the values obtained by measuring X₁ and X₂ in the manner described below.

The value (Al/Si) X₁ of the number of atoms of Al to Si measured by the X-ray photoelectric spectrophotometry (XPS) of the inorganic fine powder is not particularly limited, and may be, for example, 0.03 to 0.52, preferably 0.10 to 0.45, and more preferably 0.14 to 0.38. The value of X₁ can be adjusted by adjusting the amount of the aqueous aluminum chloride solution to be treated in relation to the particle diameter of the silica fine particle substrate. The method of measuring X₁ value will be described later.

The value (Al/Si) X₂ of the mass ratio of Al to Si measured by the fluorescent X-ray analysis (XRF) of the inorganic fine powder is not particularly limited, and may be, for example, 0.01 to 0.30, preferably 0.05 to 0.23, and more preferably 0.10 to 0.20. The value of X₂ can be adjusted by adjusting the amount of the aqueous aluminum chloride solution to be treated in relation to the particle diameter of the silica fine particle substrate. The method of measuring X₂ value will be described later.

It is preferable that the surface of the inorganic fine powder is made hydrophobic by surface treatment in order to further improve the charging performance under a high-temperature and high-humidity environment. Examples of surface treatments may include silane coupling treatment, silicone oil treatment, carboxylic acid treatment, and the like, and may be suitably selected. That is, the inorganic fine powder is preferably a treated product obtained by treating a silica fine particle having aluminum hydroxide on the surface with a silane coupling agent. The inorganic fine powder is preferably a silicone oil-treated product of a silica fine particle having aluminum hydroxide on the surface. Further, the inorganic fine powder is preferably a carboxylic acid-treated product of a silica fine particle having aluminum hydroxide on the surface.

It is also possible to select multiple types of surface treatments, and the order of such treatments is also arbitrary.

The silane coupling agent used for the silane coupling treatment is not particularly limited, and a known silane coupling agent may be used. Examples of silane coupling agents may include hexamethyldisilazane, trimethylsilane, n-n-butyltrimethoxysilane, isobutyltrimethoxysilane, propyltrimethoxysilane, octyltriethoxysilane, decyltriethoxysilane, dodecyltriethoxysilane, trimethylchlorosilane, trimethylethoxysilane, dimethyldichlorosilane, methyltrichlorosilane, allyldimethylchlorosilane, allylphenyldichlorosilane, benzyldimethylchlorosilane, bromomethyldimethylchlorosilane, α-chloroethyltrichlorosilane, β-chloroethyltrichlorosilane, chloromethyldimethylchlorosilane, triorganosilyl mercaptan, trimethylsilyl mercaptan, triorganosilyl acrylate, vinyldimethylacetoxysilane, dimethylethoxysilane, dimethyldimethoxysilane, diphenyldiethoxysilane, 1-hexamethyldisiloxane, 1,3-divinyltetramethyldisiloxane, 1,3-diphenyltetramethyldisiloxane, and dimethylpolysiloxanes having 2 to 12 siloxane units per molecule, each terminally located unit containing one hydroxyl group attached to Si. These compounds may be used alone or in combination of at least two kinds thereof.

The silane coupling agent is preferably at least one selected from the group consisting of n-propyltrimethoxysilane, n-butyltrimethoxysilane, isobutyltrimethoxysilane, octyltriethoxysilane, and decyltriethoxysilane, more preferably at least one selected from the group consisting of isobutyltrimethoxysilane, octyltriethoxysilane, and decyltriethoxysilane, and still more preferably isobutyltrimethoxysilane.

The treatment amount of inorganic fine powder with a hydrophobic treatment agent is not particularly limited, but preferably 30% to 90% by mass and more preferably 40% to 80% by mass. Within this range, the charge stabilizing effect by OH groups on the surface of the inorganic fine powder can be made better while maintaining the hydrophobic effect by the hydrophobic treatment agent.

The powder resistivity of the inorganic fine powder is preferably 1.0×10⁸ to 2.0×10¹³ Ω·cm. With the inorganic fine powder having a powder resistivity of 1.0×10⁸ Ω·cm or more, the charge rising performance of the toner is better, and the uniformity of the density after the toner is left in a high temperature and high humidity environment is better. Also, with the powder resistivity of the inorganic fine powder of 2.0×10¹³ Ω·cm or less, over-charge is easily suppressed, and even in long-term use in a high-temperature and high-humidity environment, fogging to a non-printing part is easily improved.

The powder resistivity of the inorganic fine powder is more preferably 5.0×10⁸ to 1.0×10¹³ Ω·cm, still more preferably 1.0×10⁹ to 5.0×10¹² Ω·cm, and particularly preferably 1.0×10¹⁰ to 4.0×10¹² Ω·cm.

The powder resistivity of the inorganic fine powder can be adjusted by the number-average particle diameter of the primary particle of the inorganic fine powder substrate, the amount of aluminum hydroxide to be treated, the species of the hydrophobic treatment agent, and the amount of treatment. The method of measuring the powder resistivity of the inorganic fine powder will be described later.

The number-average particle diameter of the primary particle of the inorganic fine powder is preferably 5 to 50 nm. With the number-average particle diameter of 5 nm or more, the inorganic fine powder is externally added in a state of being uniformly dispersed on the surface of the toner with good disintegrating properties. In addition, since embedding into the toner particle surface is suppressed even in long-term use, charge rising performance in a high-temperature and high-humidity environment can be easily maintained. In contrast, with the number-average particle diameter of 50 nm or less, the toner particle can be heated and melted without obstructing the heat flow from the fixing heater, and low-temperature fixability can be easily maintained.

The number-average particle diameter of the primary particle of the inorganic fine powder can be adjusted by the number-average particle diameter of the primary particle of the inorganic fine powder substrate, the amount of aluminum hydroxide to be treated, the species of the hydrophobic treatment agent, and the amount of treatment. The method of measuring the number-average particle diameter of the primary particle of the inorganic fine powder will be described later.

The coverage ratio W_{AS} (% by area) of the inorganic fine powder on the toner particle surface, calculated from the STEM-EDS mapping image of the toner, is preferably 3.0% to 50.0% by area.

With the coverage ratio W_{AS} of the inorganic fine powder of 3.0% by area or more, the interaction between an AlOH group of aluminum hydroxide on the surface of the inorganic fine powder and the monomer unit corresponding to isophthalic acid is effectively developed, and charge degradation due to moisture under a high-temperature and high-humidity environment is further suppressed. As a result, the charge rising performance property and the charge maintenance rate are improved, the density uniformity after being left in a high temperature and high humidity environment is improved, and the image density non-uniformity is further improved. In contrast, with the coverage ratio W_{AS} of the inorganic fine powder of 50.0% by area or less, the low-temperature fixability is better, which is thus preferable. The method of calculating W_{AS} will be described later.

The coverage ratio W_{AS} of the inorganic fine powder is preferably 5.0% to 40.0% by area, more preferably 8.0% to 35.0% by area, and still more preferably 10.0% to 30.0% by area. The coverage ratio W_{AS} of the inorganic fine powder can be adjusted by the number-average particle diameter of the primary particle of the inorganic fine powder substrate, the amount of the inorganic fine powder to be added, and the conditions of the external addition treatment.

The content of the inorganic fine powder with respect to 100 parts by mass of the toner particle is preferably at 0.1 to 5.0 parts by mass and more preferably 0.2 to 2.0 parts by mass. Within the above range, the coverage ratio W_{AS} of the inorganic fine powder can be controlled, charge rising performance and charge maintenance rate in a high-temperature and high-humidity environment are improved, and the density uniformity after being left in a high-temperature and high-humidity environment is improved, and the image density non-uniformity is improved. The method of measuring the content will be described later.

When the coverage ratio of the inorganic fine powder on the toner particle surface, calculated from a STEM-EDS mapping image of the toner, is taken as W_{AS} (% by area), it is preferable that W_{AS}, M_{IPA}, and Wₚ satisfy Formula (2) below. As described above, M_{IPA} indicates the content ratio (mol %) of the monomer unit Uᵢₛₒ corresponding to isophthalic acid with respect to all monomer units corresponding to the polycarboxylic acid in the polyester resin A, and Wₚ indicates the content (% by mass) of the polyester resin A in the binder resin.

$$0.03 \leq {W}_{A S} / ( {M}_{IPA} \times {W}_{p} ) \leq 1.39 \qquad ( 2 )$$

The value of W_{AS}/(M_{IPA}×Wₚ) indicates the number of AlOH groups derived from inorganic fine powder present on the toner surface, acting on the number of isophthalic acid units in the binder resin. Accordingly, with the value of Formula (2) within the above range, the distribution state of the AlOH groups of the aluminum hydroxide on the surface of the inorganic fine powder and the distribution state of the isophthalic acid unit on the toner particle surface is well balanced. Then, interaction effects on the toner surface are developed, and charge degradation due to moisture under a high-temperature and high-humidity environment is suppressed. As a result, the charge rising performance and charge maintenance rate are further improved, the density uniformity after being left in a high-temperature and high-humidity environment is better, and the image density non-uniformity is further improved.

The value W_{AS}/(M_{IPA}×Wₚ) is more preferably 0.050 to 1.000 and still more preferably 0.100 to 0.400.

The value of W_{AS}/(M_{IPA}×Wₚ) can be adjusted by adjusting W_{AS}, M_{IPA}, and Wₚ, respectively, in the method as described above. Further, the value of W_{AS}/(M_{IPA}×Wₚ) can be obtained by calculating the values obtained by measuring W_{AS}, M_{IPA}, and Wₚ.

### Hydrotalcite Particle

The external additive may contain a hydrotalcite particle. The hydrotalcite particle represented by the following composition formula (X) may be used.

$${M}_{y}^{2 +} {{M}_{x}^{3 +} ( OH )}_{2} {A}_{( x / n )}^{n -} \cdot {mH}_{2} O \qquad ( X )$$

wherein 0<x≤0.5, y=1−x, and m≥0.

M²⁺ and M³⁺ represent divalent and trivalent metals, respectively.

M²⁺ is preferably at least one divalent metal ion selected from the group consisting of Mg, Zn, Ca, Ba, Ni, Sr, Cu, and Fe.

M³⁺ is preferably at least one trivalent metal ion selected from the group consisting of Al, B, Ga, Fe, Co, and In.

Aⁿ⁻ is an n-valent anion. Examples thereof may include CO₃²⁻, OH⁻, Cl⁻, I⁻, F⁻, Br⁻, SO₄²⁻, HCO₃⁻, CH₃COO⁻, and NO₃⁻, and a single or multiple species thereof may be present.

The hydrotalcite particle preferably contains at least Al ions as M³⁺. It is also preferable to at least contain Mg ions as M²⁺.

The hydrotalcite particle may be a solid solution containing a plurality of different elements. Also, a trace amount of monovalent metal may be included.

### Colorant

The toner particle may contain a colorant. A known pigment and a known dye may be used as the colorant. A pigment is preferable as the colorant from the viewpoint of excellent weather resistance.

Examples of cyan colorants may include a copper phthalocyanine compound and a derivative thereof, an anthraquinone compound, a base dye lake compound, and the like.

Specific examples thereof may include: C.I.Pigment Blue 1, 7, 15, 15:1, 15:2, 15:3, 15:4, 60, 62, and 66.

Examples of magenta colorants may include a condensed azo compound, a diketo-pyrrolo-pyrrole compound, an anthraquinone compound, a quinacridone compound, a basic dye lake compound, a naphthol compound, a benzimidazolone compound, a thioindigo compound, a perylene compound, and the like.

Specific examples thereof may include: C.I.Pigment Red 2, 3, 5, 6, 7, 23, 48:2, 48:3, 48:4, 57:1, 81:1, 122, 144, 146, 150, 166, 169, 177, 184, 185, 202, 206, 220, 221, and 254, and C.I.Pigment Violet 19.

Examples of yellow-based colorants may include a condensed azo compound, an isoindolinone compound, an anthraquinone compound, an azo metal complex, a methine compound, an allylamide compound, and the like.

Specific examples thereof may include the following: C.I.Pigment Yellow 12, 13, 14, 15, 17, 62, 74, 83, 93, 94, 95, 97, 109, 110, 111, 120, 127, 128, 129, 147, 151, 154, 155, 168, 174, 175, 176, 180, 181, 185, 191, and 194.

Examples of black colorants may include those color-matched in black using the yellow colorant, the magenta colorant, and the cyan colorant mentioned above, and the carbon black magnetic body.

These colorants can be used alone or in mixtures, and even in the form of solid solutions. The colorant is preferably used in an amount from 1.0 to 20.0 parts by mass with respect to 100.0 parts by mass of the binder resin. In the case where a production method in an aqueous medium described below using a magnetic body is applied, a hydrophobic treatment may also be performed for the purpose of stably including the magnetic body in the resin.

### Charge Control Agent

The toner particle may contain a charge control agent. A known charge control agent may be used. In particular, a charge control agent that has a high triboelectric charging speed and can stably maintain a constant triboelectric charge quantity is preferable. Furthermore, when the toner particle is produced by a suspension polymerization method, a charge control agent that shows low polymerization inhibition performance and contains substantially no soluble matter in an aqueous medium is particularly preferred.

Examples of charge control agents capable of controlling the toner to be negatively charged may include a monoazo metal compound, an acetylacetone metal compound, a metal compound of an aromatic oxycarboxylic acid, an aromatic dicarboxylic acid, an oxycarboxylic, and a dicarboxylic acid, an aromatic oxycarboxylic acid, and an aromatic mono- and poly-carboxylic acid, and a metal salt, an anhydride, and an ester thereof, a phenol derivative such as a bisphenol, a urea derivative, a metal-containing salicylic acid compound, a metal-containing naphthoic acid compound, a boron compound, a quaternary ammonium salt, a calixarene, a charge control resin, and the like. That is, the charge control agent may contain a charge control resin.

Examples of charge control resins may include a resin having a sulfone functional group, such as a sulfonic acid group, a sulfonic acid salt group, and a sulfonic acid ester group. As such a resin, preferable is a polymer containing at least one selected from the group consisting of a sulfonic acid group-containing acrylamide-based monomer and a sulfonic acid group-containing methacrylamide-based monomer in a copolymerization ratio of preferably 2% by mass or more, more preferably 5% by mass or more.

The charge control resin preferably has a glass transition temperature (Tg) of from 35° C. to 90° C., a peak molecular weight (Mp) of from 10000 to 30000, and a weight-average molecular weight (Mw) of from 25000 to 50000. When this is used, it is easy to impart preferable triboelectric charging characteristics without affecting the thermal characteristics required for the toner particle. Further, when the charge control resin contains a sulfonic acid group, for example, the dispersibility of the charge control resin itself in the polymerizable monomer composition and the dispersibility of a colorant or the like are improved, and tinting strength, transparency, and triboelectric charging characteristics can be further improved.

These charge control agents or charge control resins may be added alone or in combination of two or more thereof. The amount of a charge control agent or a charge control resin to be added is preferably from 0.01 to 20.0 parts by mass and more preferably from 0.5 to 10.0 parts by mass with respect to 100.0 parts by mass of the binder resin.

Furthermore, the average circularity of the toner is preferably 0.950 to 0.980. Within this range, the transferability is better under a wide range of environments, and better images can be obtained even in long-term durability use. Specifically, with an average circularity of 0.950 or more, the non-electrostatic attachment force between toner particles is not excessively high even in long-term durability use under a high-temperature and high-humidity environment, which makes it easier to maintain good transferability. For this reason, the density uniformity of the solid image is better, which is thus preferable.

In contrast, with an average circularity of 0.980 or less, an appropriate non-electrostatic attachment force between the toner particles is likely to be obtained, even under a low-temperature and low-humidity environment where the non-electrostatic attachment force between the toner particles is likely to be lowered. Then, the scattering of the toner in the transfer step can be suppressed, and dot reproducibility is better, which is thus preferable. Furthermore, the average circularity of the toner is more preferably 0.955 to 0.975.

In order to adjust the average circularity of the toner, it is preferable to employ a method of producing a chemical toner, such as an emulsion aggregation method, a suspension polymerization method, or a suspension granulation method, as a method of producing the toner particle.

In the case of using the emulsion aggregation method, it is preferable to adjust the circularity by providing a spheroidizing step in order to obtain the desired surface profile of the toner particle.

In the case where the pulverization method is used, the circularity of the toner can be adjusted by performing the surface treatment with hot air current by a heat spheroidizing treatment.

### Method of Producing Toner

The method of producing a toner is not particularly limited, and a known method such as a pulverization method, a suspension polymerization method, a dissolution suspension method, an emulsion aggregation method, or a dispersion polymerization method can be used. Here, the toner is preferably produced by the method described below. That is, the toner is preferably produced by an emulsion aggregation method.

The method of producing a toner preferably includes the following steps (1) to (3):
(1) a dispersion step of preparing a binder resin fine particle dispersion containing a binder resin;
(2) an aggregation step of aggregating binder resin fine particle contained in the binder resin fine particle dispersion to form aggregates; and
(3) a fusion step of heating and fusing the aggregates
   in this order.

In addition, the method of producing a toner preferably includes, during or after the fusion step, the following steps (4) to (6):
(4) a spheroidizing step of heating the aggregates at a higher temperature;
(5) a cooling step of cooling the aggregates at a cooling rate of at least 0.1° C./sec; and
(6) an annealing step of heating and retaining the aggregates at a temperature equal to or higher than a crystallization temperature or a glass transition temperature of the binder resin
   in this order.

When the toner is produced by an emulsion aggregation method, the polyester resin A is likely to be uniformly dispersed in the vicinity of the surface, and the toner shape can be controlled, which is thus preferable. Hereinafter, the emulsion aggregation method will be described in detail.

### Emulsion Aggregation Method

The emulsion aggregation method is a method in which an aqueous fine particle dispersion that is formed of a constituent material of a toner particle and sufficiently small in relation to a target particle diameter is prepared in advance, the fine particles thereof are aggregated in an aqueous medium until the diameter reaches a particle diameter of the toner particle, and a resin is fused by heating or the like to produce a toner particle.

In the emulsion aggregation method, for example, a toner particle is produced through a dispersion step of preparing a fine particle dispersion composed of a constituent material of a toner particle, an aggregation step of aggregating fine particles containing a constituent material of the toner particle and controlling a particle diameter until the particle diameter of the toner particle is obtained, a fusion step of subjecting a resin contained in the obtained aggregated particle for melt adhesion, a spheroidizing step of melting the toner particle by heating or the like and controlling a surface profile of a toner, a subsequent cooling step, a metal removal step of filtering the obtained toner and removing excessive polyvalent metal ions, a filtration and washing step of washing the toner particle with ion exchange water or the like, and a step of removing moisture of the washed toner particle and drying the toner particle.

### Step of Preparing Resin Fine Particle Dispersion (Dispersion Step)

The resin fine particle dispersion can be prepared by a known method, but is not limited to these methods. Examples of known methods include an emulsion polymerization method, a self-emulsification method, a phase inversion emulsification method in which an aqueous medium is added to a resin solution dissolved in an organic solvent to emulsify the resin, and a forced emulsification method in which a resin is forcibly emulsified by high-temperature treatment in an aqueous medium without using an organic solvent.

Specifically, a binder resin is dissolved in an organic solvent in which the binder resin can be dissolved, and a surfactant or a basic compound is added. At that time, when the binder resin is a crystalline resin having a melting point, the resin only needs to be heated to a temperature equal to or higher than the melting point and dissolved.

Subsequently, an aqueous medium is slowly added to precipitate a resin fine particle while stirring with a homogenizer or the like. After that, the solvent is removed by heating or reducing the pressure to prepare an aqueous dispersion of a resin fine particle.

As the organic solvent used to dissolve the binder resin, any organic solvent can be used as long as it can dissolve the binder resin and is not limited, and it is preferable to use an organic solvent that forms a uniform phase with water, such as toluene, from the viewpoint of suppressing the generation of coarse powder.

The surfactant to be used in the emulsification is not particularly limited, and examples thereof include an anionic surfactant such as a sulfuric acid ester salt-based surfactant, a sulfonate-based surfactant, a carboxylate-based surfactant, a phosphate-based surfactant, or a soap-based surfactant; a cationic surfactant such as an amine salt-based surfactant or a quaternary ammonium salt-based surfactant; and a nonionic surfactant such as a polyethylene glycol-based surfactant, an alkylphenol ethylene oxide adduct-based surfactant, or a polyhydric alcohol-based surfactant. The surfactants may be used alone or in combination of at least two kinds thereof.

Examples of the basic compound used in the dispersion step include an inorganic base such as sodium hydroxide or potassium hydroxide; and an organic base such as ammonia, triethylamine, trimethylamine, dimethylaminoethanol, or diethylaminoethanol. The basic compounds may be used alone or in combination of at least two kinds thereof.

In addition, the 50% particle diameter (D50) on a volume distribution basis of binder resin fine particle in the binder resin fine particle dispersion is preferably 0.05 μm to 1.0 μm, and more preferably 0.05 μm to 0.4 μm. By adjusting the 50% particle diameter (D50) on a volume distribution basis to the above range, it is easy to obtain a toner particle having a volume-average particle diameter of 3 μm to 10 μm, which is an appropriate volume-average particle diameter of the toner particle.

It should be noted that a dynamic light scattering particle size distribution analyzer Nanotrac UPA-EX150 (manufactured by Nikkiso Co., Ltd.) is used to measure the 50% particle diameter (D50) on a volume dispersion basis.

### Colorant Fine Particle Dispersion

If necessary, a colorant fine particle dispersion may be used in an emulsion aggregation method. The colorant fine particle dispersion can be prepared by the following known method, but is not limited to these methods. The colorant fine particle dispersion can be prepared by mixing a colorant, an aqueous medium, and a dispersing agent with a mixing machine such as a known stirrer, emulsifier, or disperser. As the dispersing agent used herein, a known dispersing agent such as a surfactant or a polymer dispersing agent may be used.

Any dispersing agent of the surfactant and the polymer dispersing agent can be removed in the washing step described below, and a surfactant is preferable from the viewpoint of washing efficiency.

Examples of surfactants may include an anionic surfactant such as a sulfuric acid ester salt-based surfactant, a sulfonate-based surfactant, a phosphoric acid ester-based surfactant, or a soap-based surfactant; a cationic surfactant such as an amine salt-based surfactant or a quaternary ammonium salt-based surfactant; and a nonionic surfactant such as a polyethylene glycol-based surfactant, an alkylphenol ethylene oxide adduct-based surfactant, or a polyhydric alcohol-based surfactant. Among them, a nonionic surfactant or an anionic surfactant is preferable. In addition, a nonionic surfactant and an anionic surfactant may be used in combination. The surfactants may be used alone or in combination of at least two kinds thereof. The concentration of the surfactant in the aqueous medium is preferably 0.5 mass % to 5 mass %.

The content of the colorant fine particle in the colorant fine particle dispersion is not particularly limited, and is preferably 1 to 30 mass % in relation to the total mass of the colorant fine particle dispersion.

In addition, it is preferable that a dispersion particle diameter of the colorant fine particle in the aqueous dispersion of the colorant has a 50% particle diameter (D50) on a volume distribution basis of 0.5 μm or less from the viewpoint of the dispersibility of the colorant in the finally obtained toner. In addition, for the same reason, a 90% particle diameter (D90) on a volume distribution basis is preferably 2 μm or less.

The dispersed particle diameter of the colorant fine particle in the colorant fine particle dispersion is measured by a dynamic light scattering particle sizer distribution meter (NANOTRAC UPA-EX150: manufactured by Nikkiso Co., Ltd.).

Examples of mixers such as a known stirrer, emulsifier, or disperser used when dispersing a colorant in an aqueous medium may include an ultrasonic homogenizer, a jet mill, a pressure type homogenizer, a colloid mill, a ball mill, a sand mill, and a paint shaker. These mixers may be used alone or in combination.

### Release Agent Fine Particle Dispersion

If necessary, a release agent fine particle dispersion may be used in an emulsion aggregation method. The release agent fine particle dispersion can be prepared by the following known methods, but is not limited to these methods.

The release agent fine particle dispersion can be prepared by adding a release agent to an aqueous medium containing a surfactant, heating the resulting mixture to a temperature equal to or higher than the melting point of the release agent, dispersing the mixture in the form of particle with a homogenizer (for example, “CLEARMIX W Motion” manufactured by M Technique Co., Ltd.) or a pressure discharge type disperser (for example, “Gaulin homogenizer” manufactured by Gaulin Corporation) having a strong shearing ability, and then cooling the mixture to a temperature lower than the melting point of the release agent.

The dispersion particle diameter of the release agent fine particle in the release agent fine particle dispersion preferably has a 50% particle diameter (D50) on a volume distribution basis of from 0.03 μm to 1.0 μm, and more preferably 0.1 μm to 0.5 μm. In addition, it is preferable that no coarse particle of 1 μm or larger is present.

With the dispersion particle diameter of the release agent fine particle dispersion within the above range, the release agent can be made to exist in a finely dispersed state in the toner, and the outmigration effect at the time of fixing can be exhibited to the maximum, and good separability can be obtained.

The dispersed particle diameter of the release agent fine particle in the release agent fine particle dispersion is measured by a dynamic light scattering particle size distribution meter (NANOTRAC UPA-EX150: manufactured by Nikkiso Co., Ltd.).

### Mixing Step

The method of producing the toner may include a mixing step. In the mixing step, a mixed liquid obtained by mixing the resin fine particle dispersion, and as necessary, at least one of the release agent fine particle dispersion and the colorant fine particle dispersion is prepared. The mixing step can be performed using a known mixing device such as a homogenizer or a mixer.

### Step of Forming Aggregate Particle (Aggregation Step)

In the aggregation step, binder resin fine particles contained in the binder resin fine particle dispersion prepared in the mixing step are aggregated to form an aggregate having a target particle diameter. In this case, a flocculant is added and mixed, and at least one of the heating and mechanical power is applied as necessary and as appropriate to form an aggregate obtained by aggregating resin fine particle, and, if necessary, at least one of a release agent fine particle and a colorant fine particle.

Examples of the flocculant may include a cationic surfactant of a quaternary salt and an organic flocculant such as polyethyleneimine; an inorganic metal salt such as sodium sulfate, sodium nitrate, sodium chloride, calcium chloride, or calcium nitrate; an inorganic ammonium salt such as ammonium sulfate, ammonium chloride, or ammonium nitrate; and an inorganic flocculant such as a divalent or higher-valent metal complex. In addition, it is also possible to add an acid so as to cause soft aggregation by lowering the pH, and for example, sulfuric acid, nitric acid, or the like can be used.

The flocculant may be added in any form of a dry powder and an aqueous solution dissolved in an aqueous medium, and in order to cause uniform aggregation, the flocculant is preferably added in the form of an aqueous solution. The addition and mixing of the flocculant are preferably performed at a temperature equal to or lower than the glass transition temperature or melting point of the resin contained in the mixed liquid. By mixing under this temperature condition, aggregation proceeds relatively uniformly. The mixing of the flocculant into a mixed liquid can be performed using a known mixing device such as a homogenizer or a mixer. The aggregation step is a step of forming aggregates of the toner particle size in an aqueous medium.

The volume-average particle diameter of the aggregates produced in the aggregation step is preferably 3 μm to 10 μm. The volume-average particle diameter can be measured by a particle size distribution analyzer based on a Coulter method (Coulter multisizer III: manufactured by Beckman Coulter, Inc.).

### Step of Obtaining Dispersion Containing Toner Particle (Fusion Step)

In the fusion step, the aggregates obtained in the aggregation step are fused by heating. Specifically, for example, the aggregation is terminated in the dispersion containing the aggregate under stirring similar to the aggregation step. The aggregation is terminated by adding an aggregation terminating agent such as a base, a chelate compound, or an inorganic salt compound, such as sodium chloride, that can adjust the pH.

After the dispersion state of the aggregated particle in the dispersion is stable by the action of the aggregation terminating agent, the dispersion is heated to a temperature equal to or higher than the glass transition temperature or the melting point of a binder resin, and the aggregated particle are fused to adjust the particle diameter to the desired particle diameter. A 50% particle diameter (D50) on a volume basis of the toner particle is preferably 3 μm to 10 μm.

The temperature at the heating is not particularly limited, but, for example, is 40° C. to 60° C.

The time of heating is not particularly limited but, for example, is preferably 1 to 5 hours.

### Step of Obtaining Toner Having Desired Surface Profile (Spheroidizing Step)

It is preferable that the method of producing a toner has a spheroidizing step of heating aggregates at a higher temperature during or after the fusion step. The spheroidizing step is a step of retaining the toner particle at a desired temperature until the toner particle has a desired circularity or surface profile. A specific temperature during the spheroidizing step is, for example, 90° C. or higher, preferably 92° C. or higher, and preferably 95° C. or lower. Examples of a heating time in the spheroidizing step may include heating times of at least 3 hours, at least 5 hours, and at least 8 hours.

### Cooling Step

The method of producing the toner preferably includes, after the spheroidizing step, a cooling step of cooling the aggregates at a cooling rate of 0.1° C./sec or more. The cooling step is a step of cooling the dispersion containing a toner particle obtained by the spheroidizing step while controlling the cooling rate to a temperature lower than the crystallization temperature or a glass transition temperature of the binder resin. Through the cooling step, uneven surface formation of the toner particle due to volume change such as expansion or contraction of the material in the toner particle is suppressed. A specific cooling rate is at least 0.1° C./sec, preferably at least 0.5° C./sec, more preferably at least 2° C./sec, and still more preferably at least 4° C./sec.

### Annealing Step

The method of producing the toner preferably has an annealing step of heating and retaining the aggregates at a temperature equal to or higher than the crystallization temperature or the glass transition temperature of the binder resin. The annealing step is a step of heating and retaining the aggregates at a temperature equal to or higher than the crystallization temperature or equal to or higher than the glass transition temperature of the binder resin and, if a release agent is included, at a temperature equal to or lower than the crystallization temperature of the release agent after the cooling step. Since the above volume change can be further suppressed through the annealing step, the occurrence of recesses on the toner particle surface can be suppressed, and the circularity or surface profile can be controlled. A specific annealing temperature is from 45° C. to 75° C., preferably from 50° C. to 70° C., and still more preferably from 55° C. to 65° C. The heat treatment time of the annealing step is, for example, within 5 hours, preferably 2 to 3 hours.

### Post-Treatment Step

In the method of producing a toner, a post-treatment step such as a washing step, a solid-liquid separation step, or a drying step may be further performed, and a toner particle in a dried state is obtained by performing the post-treatment step.

### External Addition Step

The method of producing the toner may include an external addition step. In the external addition step, inorganic fine powder is externally added to the toner particle obtained in the drying step, if necessary. Other known fine particle may be used in combination if necessary.

The amount of the inorganic fine powder to be added is not particularly limited, but, for example, may be from 0.1 to 5.0 parts by mass in relation to 100 parts by mass of the toner particle. The amount of the inorganic fine powder to be added is preferably from 0.2 to 3.0 parts by mass and more preferably from 0.2 to 2.0 parts by mass from the viewpoint of balancing the durability and the low-temperature fixability, including the charge maintenance characteristics of the toner.

Next, a method of measuring each physical property will be described.

### Isolation Method of Inorganic Fine Powder, and Method of Measuring Content of Inorganic Fine Powder in Toner Particle

In 100 g ion exchange water, 0.50 g of Triton-X₁₀₀ (manufactured by Kishida Chemical Co., Ltd.) is put to prepare the dispersion medium.

(1) 1.00 g of the toner is weighed exactly in a vial bottle, and the dispersion medium is added to be 10.00 g, and then left for 24 hours to prepare a sample liquid.

(2) The sample liquid is subjected to an ultrasonic homogenizer treatment to release the external additive from the toner and disperse the released external additive in the dispersion medium. The apparatuses and conditions used in this step are described below.

Ultrasound treatment device: Ultrasound homogenizer VP-050 (manufactured by TAITEC Corporation)
Microchip: Stepped microchip, tip diameter φ2 mm
Tip position of microchip: The central portion of the glass vial at a height of 5 mm from the bottom surface of the vial
Ultrasound conditions: Intensity 30%, 180 min. At this time, ultrasonic waves are applied while cooling the vial with ice water so that the temperature of the dispersion should not rise.

(3) The toner particle in the sample solution is separated from the dispersion medium (filtrate) in which the external additive is dispersed by suction filtration (10 μm membrane filter).

(4) The filtered toner particle is collected and the dispersion medium is added again to be 10.00 g, and then the above steps (2) and (3) are repeated 10 times in total to collect all filtrate.

(5) If other external additives are externally added, the recovered filtrate is set to a centrifugal separator to separate other external additives and collect the inorganic fine powder.

(6) The collected inorganic fine powder is sufficiently dried in a vacuum drier at 60° C. for 24 hours to isolate the dried inorganic fine powder.

The mass of the dried inorganic fine powder is measured, the toner particle is isolated by the method described below, and the mass of the isolated toner particle is measured to determine the parts by mass of the inorganic fine powder contained in 100 parts by mass of the toner particle.

### Method of Measuring Number-Average Particle Diameter (D1) of Inorganic Fine Powder

The number-average particle diameter (D1) of the primary particle of the inorganic fine powder is measured using a scanning electron microscope “S-4800” (trade name; manufactured by Hitachi, Ltd.).

The number-average particle diameter (D1) is determined by observing the toner to which the inorganic fine powder is externally added and randomly measuring the major diameters of 100 primary particles of the inorganic fine powder so as not to become arbitrary in the field of view magnified up to 200,000 times. When there are a plurality of kinds of inorganic fine powder, the number-average particle diameter (D1) is determined by simultaneously acquiring an element mapping image using energy-dispersive X-ray spectroscopy when acquiring an electron microscope image, and measuring the major diameters of particles existing at a position where silicon and aluminum are detected. An observation magnification is adjusted, as appropriate, depending on the size of the inorganic fine powder.

### X-Ray Fluorescence Analysis of Inorganic Fine Powder

The measurement of inorganic fine powder based on fluorescent X-ray analysis (XRF) is performed by the following procedure.

As the measuring instrument, a wavelength-dispersive X-ray fluorescence spectrometer “Axios” (manufactured by PANalytical Co., Ltd.) and an attached dedicated software “SuperQ Ver. 4.0F” (manufactured by PANalytical Co., Ltd.) for setting measurement conditions and analyzing measurement data are used. The elements from Na to U in the inorganic fine powder are directly measured under a He atmosphere. Using a cup for a liquid sample attached to the device, a 6 μm-thick mylar film is applied to the bottom surface, a sufficient amount of the isolated inorganic fine powder is charged, a layer is formed on the bottom surface to a uniform thickness, and the lid is closed. The net strength of the aluminum and silicon elements obtained by measuring under conditions of power of 2.4 kW is taken as the content of aluminum and silicon in the inorganic fine powder. The intensity ratio Al (kcps)/Si (kcps) of these is taken as X₂.

### X-Ray Photoelectric Spectrophotometry of Inorganic Fine Powder

The measurement of the inorganic fine powder based on X-ray photoelectric spectrophotometry analysis (XPS) is performed by the following procedure.

The isolated inorganic fine powder is measured under the following conditions:

The device and the measurement conditions of XPS are as follows.
Device used: Quantum 2000 manufactured by ULVAC-PHI, Inc.
Analytical methods: Narrow analysis

### Measurement Conditions:

X-ray source: Al-Kα
X-ray conditions: Beam diameter: 100 μm, 25 W, 15 kV
Photoelectronic uptake angle: 45°
PassEnergy: 58.70 eV
Measurement range: φ100 μm

The analytical method is as follows. First, the peak corresponding to the C—C bond of the carbon 1s orbital is corrected to 285 eV. Then, the ratio A (atomic %) of silicon atoms and the ratio B (atomic %) of aluminum atoms are calculated from the peak area corresponding to the silicon 2p orbital where the peak top is detected from 100 eV to 105 eV and the peak area corresponding to the aluminum 2p orbital where the peak top is detected from 72.5 eV to 74.6 eV by using a relative sensitivity factor provided by ULVAC-PHI, Inc. The ratio B/A is taken as X₁.

### Method of Measuring X-Ray Diffraction Pattern of Inorganic Fine Powder

The crystal system of the inorganic fine powder can be identified by X-ray diffraction analysis of the inorganic fine powder taken from the toner.

The X-ray diffraction measurement uses a measuring instrument, “RINT-TTRII” (manufactured by Rigaku Corporation), and control software and analysis software attached to the instrument. The measurement conditions are as described below.
X-ray: Cu/50 kV/300 mA
Goniometer: Rotor horizontal goniometer (TTR-2)
Attachment: Standard sample holder
Divergent slit: Release
Divergence vertical restriction slit: 10.00 mm
Scattering slit: Opened
Light-receiving slit: Opened
Counter: Scintillation counter
Scan mode: Continuous
Scan speed: 4.0000°/min
Sampling width: 0.0200°
Scanning axis: 2 θ/deg
Scanning range: 3.0000° to 60.0000°

The resulting spectra are analyzed by the software attached to the device to identify crystalline structures. If the inorganic fine powder is composed of amorphous silica and aluminum hydroxide, no clear peak is detected. Meanwhile, if the aluminum component contains aluminum oxide (Al₂O₃), a clear peak reflecting the alumina crystalline structure is detected.

### Isolation Method of Toner Particle

In the step (4) of the <Isolation Method of Inorganic Fine Powder, and Method of Measuring Content of Inorganic Fine Powder in Toner Particle>, the obtained toner particle is collected by repeating filtration ten times. The resulting toner particle is then dried at 45° C. for 24 hours to isolate the toner particle.

Isolation Method of Binder Resin from Toner Particle
Method of Isolating Binder Resin from Toner Particle

100 mg of the toner particle isolated by the above method are dissolved in 3 mL of chloroform. Then, the chloroform-insoluble matter is removed by suction filtration with a syringe to which a sample treatment filter (pore size: from 0.2 μm to 0.5 μm; for example, My Shori Disk H-25-2 (manufactured by Tosoh Corporation) is used). A chloroform-soluble matter is introduced into a preparative HPLC (instrument: LC-9130 NEXT manufactured by Japan Analytical Industry Co., Ltd, preparative column [60 cm], exclusion limit: 20000, 70000, two columns are connected), and a chloroform eluent is sent. When a peak is observed by the obtained chromatographic display, the retention time at which the molecular weight is 2000 or more in the monodispersed polystyrene standard sample is separated. The solution of the obtained fraction is dried and solidified to separate the binder resin from the release agent.

### Composition Analysis of Polyester Resin A and Crystalline Polyester

The separated chloroform-soluble matter of the binder resin is used as a sample. The sample is adjusted so that the concentration of the toner particle be 0.1 mass % in chloroform, and the solution was filtered through a 0.45 μm PTFE filter, which is then subjected to measurement. The gradient polymer LC measurement conditions are shown below.
Device: ULTIMATE 3000 (manufactured by Thermo Fisher Scientific Inc.)
Mobile phase: A: chloroform (HPLC), B: acetonitrile (HPLC)
Gradient: 2 min (A/B=0/100)→25 min (A/B=100/0)

(It should be noted that the gradient of the change in the mobile phase is made linear.)
Flow rate: 1.0 mL/min
Injection: 0.1 mass %×20 μL
Column: Tosoh TSKgel ODS (4.6 mmφ×150 mm×5 μm)
Column temperature: 40° C.
Detector: Corona charged particle detector (Corona-CAD) (manufactured by Thermo Fisher Scientific Inc.)

The polyester resin A is separated at a separating time corresponding to the polyester resin A. The crystalline polyester is also separated at a separating time corresponding to the crystalline polyester. In the separation process, the respective chloroform/acetonitrile solutions are collected in required amounts, dried, and concentrated, and then samples of the polyester resin A and the crystalline polyester are provided. The content Wₚ of the polyester resin A in the binder resin is calculated from the amount of the obtained polyester resin A and the amount of the separated binder resin.

A sample of the polyester resin A component is used to measure the composition ratio and mass ratio by nuclear magnetic resonance (NMR) spectroscopy as follows.

To 20 mg of a sample of the polyester resin A, 1 mL of chloroform-d is added, and the NMR spectrum of the proton of the dissolved resin is measured. The molar ratio and mass ratio of each monomer can be calculated from the obtained NMR spectrum to determine the content ratio of each monomer unit.

Nuclear magnetic resonance spectroscopy (NMR) can use the following instrument and measurement conditions.
NMR apparatus: RESONANCE ECX 500 manufactured by JEOL Ltd.
Observation nuclei: Proton
Measurement mode: Single pulse
   Method of Quantitating Uᵢₛₒ, U_{EO}, and U_{PO} in Polyester Resin A by NMR Measurement

### Identification of Components of Polyester Resin A and Measurement of Molar and Mass Ratios by Nuclear Magnetic Resonance (NMR) Spectroscopy

To 20 mg of the resulting polyester resin A, 1 mL of chloroform-d is added, and the proton NMR spectrum of the dissolved polyester resin A is measured. From the obtained NMR spectrum, the molar ratio and mass ratio of each monomer are calculated with the minimum unit sandwiched between ester bonds as a structure derived from the monomer.

For example, the composition ratio and mass ratio can be calculated on the basis of the following peaks (chemical shift value, proton number):
Units derived from isophthalic acid: 7.5 ppm (1), 8.2 ppm (2), and 8.7 ppm (1)
Unit derived from terephthalic acid: 8.1 ppm (4)
Units derived from bisphenol A ethylene oxide adduct: 1.6 ppm (6), 4.3 ppm (4), 4.7 ppm (4), 6.8 ppm (4), and 7.1 ppm (4)
Units derived from bisphenol A propylene oxide adduct: 1.5 ppm (6), 1.6 ppm (6), 4.1 ppm (4), 5.5 ppm (2), 6.8 ppm (4), and 7.1 ppm (4)
Unit derived from ethylene glycol: 4.3 ppm (4)
NMR apparatus: JEOL RESONANCE ECX500
Observation nuclear: Proton measurement mode: Single-pulse reference peak: TMS

By the NMR analysis, the content ratio (mol %) of the monomer unit Uᵢₛₒ corresponding to isophthalic acid to all monomer units corresponding to polycarboxylic acid is determined. Also, the total (mol %) of the U_{EO} content ratio and the U_{PO} content ratio with respect to all monomer units corresponding to polyol is determined. Then, the content ratio (parts by mole) of the U_{EO} is determined when the sum of the content ratio of the U_{EO} and the content ratio of the U_{PO} is taken as 100 parts by mole.

When the standard for the content ratio is represented mass % or parts by mass, it is determined in the same manner as described above.

### Method of Measuring Weight-Average Molecular Weight and Number Average Molecular Weight

The molecular weight of the samples of the polyester resin A, a crystalline polyester, a styrene acrylic resin, or the like is measured by gel permeation chromatography (GPC) as follows.

First, a sample is dissolved in tetrahydrofuran (THF). In the case of the polyester resin A or the styrene acrylic resin, it is dissolved in THF at room temperature over 24 hours. In the case of a crystalline polyester, THF is warmed to 40° C. and the crystalline polyester is dissolved therein, and then left for 24 hours.

The solution in which each sample is dissolved is filtrated through a solvent-resistant membrane filter, “My Shori Disk” (manufactured by Tosoh Corporation), with a pore diameter of 0.2 μm to obtain a sample solution. It should be noted that the sample solution is adjusted so that the concentration of the component soluble in THE be 0.8 mass %. The sample solution is used to measure under the following conditions.
Instrument: HLC-8120 GPC (detector: RI) (manufactured by Tosoh Corporation)
Column: Seven series of Shodex KF-801, 802, 803, 804, 805, 806, and 807 (manufactured by Showa Denko K.K.)
Eluent: Tetrahydrofuran (THF)
Flow Rate: 1.0 mL/min.
Oven temperature: 40.0° C.
Sample injection amount: 0.10 mL

In the calculation of the molecular weight of the sample, a molecular weight calibration curve created using a standard polystyrene resin (for example, trade name “TSK standard polystyrene F-850, F-450, F-288, F-128, F-80, F-40, F-20, F-10, F-4, F-2, F-1, A-5000, A-2500, A-1000, and A-500” manufactured by Tosoh Corporation) is used.

The value of the ratio of the weight-average molecular weight to the number average molecular weight is calculated from the obtained weight-average molecular weight and the number average molecular weight.

### Method of Measuring Melting Point

The melting points of samples of crystalline polyesters, release agents, plasticizers, and the like are measured using a differential scanning calorimeter (DSC) Q2000 (manufactured by TA Instruments) under the following conditions.
Ramp rate: 10° C./min
Measurement start temperature: 20° C.
Measurement end temperature: 180° C.

The melting points of indium and zinc are used for correcting the temperature of the device detection unit, and the heat of fusion of indium is used for correcting the amount of heat.

Specifically, about 5 mg of the sample is weighed exactly, placed in an aluminum pan, and measured once. As a reference, an empty pan made of aluminum is used. The peak temperature of the maximum endothermic peak at that time is taken as the melting point.

### Measurement of Glass Transition Temperature Tg

The glass transition temperature Tg is measured according to ASTM D3418-82 using a differential scanning colorimeter “Q2000” (manufactured by TA Instruments). The melting points of indium and zinc are used for correcting the temperature of the device detection unit, and the heat of fusion of indium is used for correcting the amount of heat. Specifically, about 2 mg of the sample is weighed exactly and placed in an aluminum pan. An empty aluminum pan is used as a reference. Then, the measurement is performed within the measurement temperature range of −10° C. and 200° C. at a ramp rate of 10° C./min. In the measurement, the temperature is raised once to 200° C., subsequently the temperature is dropped to −10° C., and after that, the temperature is raised again. The specific heat change is obtained in the temperature range of 30° C. to 100° C. during this second temperature-raising process. The intersection between the line at the midpoint of the baseline before and after the specific heat change occurs and the differential thermal curve is taken as the glass transition temperature Tg.

### Measurement of Acid Value

An acid value is the number of milligrams of potassium hydroxide required to neutralize acids contained in 1 gram of a sample. The acid value in the present disclosure is measured according to JIS K 0070-1992, and specifically, it is measured according to the following procedure.

Titration is performed using 0.1 mol/l potassium hydroxide ethyl alcohol solution (manufactured by Kishida Chemical Co., Ltd.). The factor of the potassium hydroxide ethyl alcohol solution can be determined using a potentiometric titration apparatus (potentiometric titration apparatus AT-510 manufactured by Kyoto Electronics Manufacturing Co., Ltd.). 100 mL of 0.100 mol/l hydrochloric acid is put in a 250-mL tall beaker, then titrated with the potassium hydroxide ethyl alcohol solution, and determined from the amount of the potassium hydroxide ethyl alcohol solution required for neutralization. The 0.100 mol/l hydrochloric acid is prepared according to JIS K 8001-1998.

The following are measurement conditions for acid value measurement.
Titrator: Potentiometric titration apparatus AT-510 (manufactured by Kyoto Electronics Manufacturing Co., Ltd.)
Electrode: composite glass electrode double junction type electrode (manufactured by Kyoto Electronics Manufacturing Co., Ltd.)
Control software for titration devices: AT-WIN
Titration analysis software: Tview
Titration and control parameters in titration are performed as follows.

### Titration Parameters

Titration Mode: Blank titration
Titration mode: Total titration
Maximum titration: 20 mL
Wait time before titration: 30 seconds
Titration direction: Automatic

### Control Parameters

Endpoint decision potential: 30 dE
Endpoint decision potential value: 50 dE/dmL
Endpoint detection decision: Not set
Control speed mode: Standard
Gain: 1
Data acquisition potential: 4 mV
Data acquisition titration amount: 0.1 mL

Main test; 0.100 g of a measurement sample is weighed exactly in a 250-mL tall beaker, 150 mL of a mixed solution of toluene/ethanol (3:1) is added thereto, and the mixture is dissolved over 1 hour. The potentiometric titration apparatus is used for titration using the potassium hydroxide ethyl alcohol solution.

Blank test; Titration is performed in the same manner as the above operation, except that no sample is used (that is, only the mixed solution of toluene/ethanol (3:1) is used). The obtained result is substituted into the following formula to calculate the acid value.

$$A = [ ( C - B ) \times f \times 5.611 ] / S$$

(In the formula, A: acid value (mgKOH/g), B: the amount (mL) of the potassium hydroxide ethyl alcohol solution added in the blank test, C: the amount (mL) of the potassium hydroxide solution added in the main test, f: the factor of the potassium hydroxide solution, and S: a sample (g).)

### Method of Measuring Average Circularity of Toner (Particle)

The average circularity of a toner or a toner particle is measured with a flow particle image analyzer, “FPIA-3000” (manufactured by Sysmex Corporation), under the measurement and analysis conditions during a calibration operation.

An appropriate amount of a surfactant and alkylbenzene sulfonate as dispersing agents are added to 20 mL of ion exchange water, 0.02 g of a measurement sample is then added, and dispersion treatment is performed for 2 minutes using a desktop ultrasonic cleaner disperser (trade name: VS-150 manufactured by VELVO-CLEAR K.K.) with an oscillation frequency of 50 kHz and an electrical output of 150 W to obtain a dispersion for measurement. At that time, the dispersion is suitably cooled so that the temperature of the dispersion be from 10° C. to 40° C.

For the measurement, a flow particle image analyzer equipped with a standard objective lens (×10 magnification) is used, and particle sheath “PSE-900A” (manufactured by Sysmex Corp.) is used as the sheath liquid. The dispersion adjusted according to the above procedure is introduced into the flow particle image analyzer, 3000 toners (toner particles) are measured in an HPF measurement mode and a total count mode, and the average circularity of the toners (toner particles) is determined in a condition where the binarization threshold for particle analysis is set at 85%, and the analysis particle diameter is limited to a circle-equivalent diameter of from 1.98 μm to 19.92 μm.

Upon the measurement, the automatic focus adjustment is performed using a standard latex particle (for example, “5100A” (trade name) manufactured by Duke Scientific Corp. is diluted with ion exchange water) before the start of the measurement. After that, it is preferable to perform focus adjustment every two hours from the start of the measurement.

### Method of Measuring Weight-Average Particle Diameter (D4) of Toner Particle

The weight-average particle diameter (D4) of the toner particle is calculated in the following manner. As a measurement instrument, a precision particle size distribution measuring instrument based on a pore electrical resistance method, “Coulter Counter Multisizer 3” (registered trademark, manufactured by Beckman Coulter, Inc.) provided with a 100 μm aperture tube is used. For setting the measurement conditions and analyzing the measurement data, the attached dedicated software “Beckman Coulter Multisizer 3 Version 3.51” (manufactured by Beckman Coulter, Inc.) is used. It should be noted that the measurement is performed with 25,000 effective measurement channels. As an aqueous electrolyte solution that is used for the measurement, a solution in which special grade sodium chloride is dissolved in ion exchange water to a concentration of about 1% by mass, for example, “ISOTON II” (manufactured by Beckman Coulter, Inc.), may be used.

Before measurement and analysis, the dedicated software was set as follows. On the “standard measurement method (SOM) change screen” of the dedicated software, the total count number in the control mode is set to 50,000 particles, the number of times of measurements is set to one, and the Kd value is set to a value obtained using “standard particle 10.0 μm” (manufactured by Beckman Coulter, Inc.). A threshold and a noise level are automatically set by pressing the “threshold/noise level measurement button”. In addition, the current is set to 1600 μA, the gain is set to 2, the electrolytic solution is set to ISOTON II, and the “flushing of the aperture tube after measurement” is checked. On the “conversion setting screen from pulse to particle diameter” of the dedicated software, the bin interval is set to a logarithmic particle diameter, the particle diameter bin is set to 256 particle diameter bins, and the particle diameter range is set to from 2 μm up to 60 μm.

Specific measurement methods are as follows.

1. About 200 mL of the electrolyte aqueous solution is put into a 250-mL round bottom glass beaker dedicated to the Multisizer 3, set in a sample stand, and stirred counterclockwise with a stirrer rod at 24 rotations/second. In addition, contaminations and air bubbles in the aperture tube are removed by the “flushing of aperture” function of the analysis software.

2. About 30 mL of the electrolyte aqueous solution is put into a 100-mL flat-bottom glass beaker. Then, about 0.3 mL of a diluted solution obtained by diluting “CONTAMINON N” (a 10% by mass aqueous solution of a neutral detergent for washing a precision measuring instrument having a pH of 7 composed of a nonionic surfactant, an anionic surfactant, and an organic builder, manufactured by Wako Pure Chemical Industries, Ltd.) with ion exchange water threefold by mass is added thereto as a dispersing agent.

3. Two oscillators having an oscillation frequency of 50 kHz are incorporated with the phases shifted by 180 degrees, and 3.3 L of ion exchange water is put in a water tank of an ultrasonic disperser, “Ultrasonic Dispersion System Tetora 150” (manufactured by Nikkaki Bios Co., Ltd.) having an electrical output of 120 W, and about 2 mL of the CONTAMINON N is added into this water tank.

4. The beaker in the 2. is set in a beaker fixing hole of the ultrasonic disperser, and the ultrasonic disperser is operated. In addition, the height position of the beaker is adjusted so that the resonance state of the liquid level of the electrolyte aqueous solution in the beaker be maximized.

5. In a state where the electrolyte aqueous solution in the beaker in the 4. has been irradiated with ultrasonic waves, about 10 mg of the toner is added little by little to the electrolyte aqueous solution and dispersed. In addition, an ultrasonic dispersion treatment is further continued for 60 seconds. It should be noted that, in the ultrasonic dispersion, the water temperature in the water tank is adjusted, as appropriate, to from 10° C. to 40° C.

6. The aqueous electrolytic solution in the 5. in which the toner has been dispersed is added dropwise to the round bottom beaker in the 1. set in the sample stand using a pipette, and the measurement concentration is adjusted to about 5%. In addition, the measurement is continued until the number of measurement particles reaches 50,000.

7. The measurement data is analyzed with the dedicated software attached to the device to calculate the weight-average particle diameter (D4). The “average diameter” on the “analysis/volume statistical value (arithmetic average)” screen at the time of setting graph/% by volume with the dedicated software is the weight-average particle diameter (D4).

### Method of Measuring Coverage Ratio W_{AS} of Inorganic Fine Powder on Surface of Toner Particle

The coverage ratio W_{AS} of the inorganic fine powder on the toner particle surface can be calculated from the elemental mapping image of aluminum and silicon obtained by energy-dispersive spectroscopy (STEM-EDS) using a scanning transmission electron microscope.

In EDS element mapping measurement, element mapping images can be measured with high sensitivity, even with trace elements, by using a silicon drift detector having a large detection element area. By performing statistical analysis on the spectral data of each pixel obtained by EDS element mapping measurement, a principal component mapping in which pixels having similar spectra are extracted can be obtained, and mapping in which the components are identified can be performed.

The sample for observation is prepared by the following procedures:

An appropriate amount of a liquid curable epoxy resin is put in an Eppendorf tube, a small amount of toner is added, and the mixture is agitated to disperse the toner. Sample pellets are prepared by leaving them day and night and curing the epoxy resin. Pellets are processed by ultramicrotome (Leica, Inc., FC7) to make 200 nm-thick slices and hold them in a Cu grid mesh with a support film. A slice produced by STEM is observed to obtain a transmission image near the top of the cut toner.

STEM-EDS mapping analysis is performed in the following devices and conditions.
Scanning transmission electron microscope; JEM-2800 manufactured by JEOL Ltd.
EDS detector; JED-2300 T dry SD100GV detector (detector element area: 100 mm²) available from JEOL Ltd.
EDS Analyzer; NORAN System 7 manufactured by Thermo Fisher Scientific Inc.

### STEM-EDS Conditions

Acceleration voltage for STEM: 200 kV
Magnification: 100,000 times
Probe size: 1 nm
STEM image size; 1024×1024 pixels (EDS element mapping images at the same location are gained)
EDS mapping size; 256×256 pixels, Dwell Time; 30 μs, Accumulation count; 100 frames

After the end of the measurement, quantitative mapping is obtained by the following analytical process.
Kernel size: 3×3
Quantitative map settings: High (slow)
Filter fit type: High precision (slow)

An Al—K ray mapping image and a Si—K ray EDS mapping image are obtained by the above STEM-EDS analysis. Since the inorganic fine powder has aluminum hydroxide on the surface of the silica fine particle, particles at positions detected in both the Al—K ray mapping image and the Si—K ray EDS mapping image in the observation field of view are inorganic fine powder. A mapping image obtained by the STEM-EDS mapping is analyzed by the image analysis software ImageJ. The number of pixels S1 occupied by the inorganic fine powder and the number of pixels S2 occupied by the mapped toner head top is measured from the mapping image, and (S1/S2)×100 is calculated to calculate the coverage ratio W_{AS} (%) of the inorganic fine powder on the toner particle surface.

### Method of Measuring Coverage Ratio of Aluminum Element on Inorganic Fine Powder

The coverage ratio of the aluminum element on the inorganic fine powder can be calculated from the element mapping image of aluminum and silicon obtained by energy-dispersive spectroscopy (STEM-EDS) using a scanning transmission electron microscope, similar to the <Method of Measuring Coverage Ratio W_{AS} of Inorganic Fine Powder on Surface of Toner Particle> described above.

An observation sample can be prepared by ultrasonically dispersing 10 mg of the inorganic fine powder isolated by the above method in 2 mL of a solvent such as isopropyl alcohol, then adding the resulting liquid dropwise to a Cu grid mesh with a support film, and evaporating the solvent.

STEM-EDS mapping analysis is performed in the following devices and conditions.
Scanning transmission electron microscope; JEM-2800 manufactured by JEOL Ltd.
EDS detector; JED-2300 T dry SD100GV detector (detector element area: 100 mm²) available from JEOL Ltd.
EDS Analyzer; NORAN System 7 manufactured by Thermo Fisher Scientific Inc.

### STEM-EDS Conditions

Acceleration voltage for STEM: 200 kV
Magnification: 1,000,000 times
Probe size: 0.5 nm
STEM image size; 1024×1024 pixels (EDS element mapping images at the same location are gained)
EDS mapping size; 256×256 pixels, Dwell Time; 30 μs, Accumulation count; 100 frames

After the end of the measurement, quantitative mapping is obtained by the following analytical process.
Kernel size: 3×3
Quantitative map settings: High (slow)
Filter fit type: High precision (slow)

An Al—K ray mapping image and a Si—K ray EDS mapping image are obtained by the above STEM-EDS analysis. A mapping image obtained by the STEM-EDS mapping is analyzed by the image analysis software ImageJ. The number of pixels S3 occupied by silicon in the inorganic fine powder and the number of pixels S4 occupied by aluminum are measured from the mapping image, and (S4/S3)×100 is calculated to calculate the coverage ratio (% by area) of the aluminum element to the inorganic fine powder.

### Method of Measuring Volume Resistance of Inorganic Fine Powder

The volume resistance of the inorganic fine powder is measured in the following procedure.

As the device, a 6517-type electrometer/high resistance system manufactured by Keithley Instruments is used. Electrodes of 25 mm diameter are connected, and inorganic fine powder is placed between the electrodes so that the thickness be about 0.5 mm. Then, the distance between the electrodes is measured with a load of about 2.0 N applied.

The resistance value when the voltage of 1,000 V is applied to the inorganic fine powder for one minute is measured, and the volume resistance is calculated using the following equation.

Volume resistance (Ω·cm)=R×L
R: Resistance value (Ω)
L: Inter-electrode distance (cm)

### EXAMPLES

The further details of the present disclosure will be described below with reference to Examples and Comparative Examples, but the present disclosure is not limited to these. In the unit “part(s)” used in Examples are on a mass basis unless otherwise specified.

### Production Example of Polyester Resin A-1

Bisphenol A ethylene oxide 2 mol adduct: 27 parts by mole
Bisphenol A propylene oxide 2 mol adduct: 73 parts by mole
Isophthalic acid: 100 parts by mole

The monomers described above were put in a flask equipped with a stirring device, a nitrogen inlet tube, a temperature sensor, and a rectification column, and the temperature was raised to 190° C. within 1 hour to confirm that the inside of the reaction system was uniformly stirred. To 100 parts of these monomers, 1.0 part by mass of tin distearate was added. The temperature was further raised from 190° C. to 245° C. over 5 hours while generated water was distilled off, and a dehydration condensation reaction was further performed at 245° C. for an additional 2 hours.

As a result, a polyester resin A-1 with a glass transition temperature of 60.1° C., an acid value of 9 mgKOH/g, a hydroxyl value of 25 mgKOH/g, a Mₙ of 4800, and a M_{w}/Mₙ of 6.7 was obtained.

TABLE 1

| | | | | | | | | O_{ISO}/all | (U_{EO} + |
|---|---|---|---|---|---|---|---|---|---|
| | Acid component | | Alcohol component | | | | | acids/ | U_{PO})/all |
| Polyester | IPA/ | TPA/ | BPA-EO/ | BPA-PO/ | EG/ | | M_{w}/ | mol % | alcohols/ |
| resin | mol % | mol % | mol % | mol % | mol % | Mₙ | Mₙ | M_{IPA} | mol % |
| Resin A-1 | 100 | 0 | 27 | 73 | 0 | 4800 | 6.7 | 100 | 100 |
| Resin A-2 | 100 | 0 | 27 | 73 | 0 | 8000 | 6.3 | 100 | 100 |
| Resin A-3 | 100 | 0 | 27 | 73 | 0 | 10000 | 5.2 | 100 | 100 |
| Resin A-4 | 100 | 0 | 27 | 63 | 10 | 8000 | 6.9 | 100 | 90 |
| Resin A-5 | 100 | 0 | 27 | 58 | 15 | 3600 | 5.7 | 100 | 85 |
| Resin A-6 | 90 | 10 | 15 | 85 | 0 | 3500 | 3.3 | 90 | 100 |
| Resin A-7 | 90 | 10 | 40 | 60 | 0 | 3500 | 3.2 | 90 | 100 |
| Resin A-8 | 90 | 10 | 5 | 95 | 0 | 3000 | 2.5 | 90 | 100 |
| Resin A-9 | 90 | 10 | 50 | 50 | 0 | 3000 | 2.5 | 90 | 100 |
| Resin A-10 | 60 | 40 | 27 | 73 | 0 | 5000 | 6.2 | 60 | 100 |
| Resin A-11 | 40 | 60 | 27 | 73 | 0 | 5000 | 6.2 | 40 | 100 |
| Resin A-12 | 90 | 10 | 27 | 73 | 0 | 4800 | 6.7 | 90 | 100 |
| Resin A-13 | 30 | 70 | 27 | 73 | 0 | 4700 | 6.3 | 30 | 100 |

In the table, all acids indicate all polycarboxylic acids used as the raw materials for the polyester resin A; the Uiso/all acids indicates the content ratio M_{IPA} (mol %) of monomer units corresponding to isophthalic acid with respect to all monomer units corresponding to polycarboxylic acid; all alcohols indicate all polyols used as raw materials for the polyester resin A; and (U_{EO}+U_{PO})/all alcohols indicate the sum of the content ratio of the monomer unit U_{EO} corresponding to the bisphenol A ethylene oxide adduct and the content ratio of the monomer unit U_{PO} corresponding to the bisphenol A propylene oxide adduct with respect to all monomer units corresponding to polyol in the polyester resin A.

TABLE 2

| | | | | | | | | | | | | U_{ISO}/all | (U_{EO} + |
|---|---|---|---|---|---|---|---|---|---|---|---|---|---|
| | Acid component | | | | | | Alcohol component | | | | | acids/ | U_{PO})/all |
| Polyester | IPA/ | IPA/ | AA/ | IMA/ | DSA/ | FA/ | BPA-EO/ | BPA-PO/ | EG/ | | | mol % | alcohols/ |
| resin | mol % | mol % | mol % | mol % | mol % | mol % | mol % | mol % | mol % | Mn | Mw/Mn | M_{IPA} | mol % |
| Resin A-14 | 10 | 65 | 20 | 5 | 0 | 0 | 27 | 73 | 0 | 4800 | 6.7 | 10 | 100 |
| Resin A-15 | 0 | 60 | 0 | 5 | 20 | 15 | 27 | 73 | 0 | 8000 | 6.3 | 0 | 100 |

In the table, all acids indicate all polycarboxylic acids used as the raw materials for the polyester resin A; the Uiso/all acids indicates the content ratio M_{IPA} (mol %) of monomer units corresponding to isophthalic acid with respect to all monomer units corresponding to polycarboxylic acid; all alcohols indicate all polyols used as raw materials for the polyester resin A; and (U_{EO}+U_{PO})/all alcohols indicate the sum of the content ratio of the monomer unit U_{EO} corresponding to the bisphenol A ethylene oxide adduct and the content ratio of the monomer unit U_{PO} corresponding to the bisphenol A propylene oxide adduct with respect to all monomer units corresponding to polyol in the polyester resin A.

In the tables, each abbreviation indicates the following compounds.

IPA: isophthalic acid, TPA: terephthalic acid, AA: adipic acid, TMA: trimellitic acid, DSA: dodenenylsuccinic acid, FA: fumaric acid, EG: ethylene glycol

### Production Examples of Polyester Resins A-2 to A-15

Polyester resins A-2 to A-15 were obtained in the same manner as in Production Example 1 of the polyester resin A-1, except that, in the production example of the polyester resin A-1, the monomers used were changed as listed in Tables 1 and 2 and the reaction temperature and the dehydration condensation time were changed so that the Mₙ and the M_{w}/Mₙ of the obtained polyester resin A be the values listed in Table 1 or 2. The results are shown in Tables 1 and 2.

### Production Example of Styrene Acrylic Resin

Styrene: 77 parts by mass
Butyl acrylate: 23 parts by mass
Di-t-butyl peroxide: 1.0 part by mass

200 parts by mass of xylene were heated to 200° C., then each component was added dropwise to xylene over 4 hours, and retained under xylene reflux for 1 hour to complete the polymerization.

The physical properties of the obtained styrene acrylic resin are shown in Table 3.

TABLE 3

| | Styrene acrylic resin |
|---|---|
| Styrene (parts by mass) | 77 |
| Butyl acrylate (parts by mass) | 23 |
| Mn | 12000 |
| Mw/Mn | 5.9 |

### Production Example of Crystalline Polyester 1

1,10-Decanedicarboxylic acid: 100 parts by mole
1,9-Nonanediol: 100 parts by mole
As a catalyst, 0.8 parts by mass of stannous dioctylate in relation to the total mass of the acid and alcohol

The above materials were put in a heated and dried two-necked flask equipped with a nitrogen inlet tube, a dehydration tube, a stirrer, and a thermocouple, then nitrogen gas was introduced into the vessel to keep the inside in an inert atmosphere, and the materials were heated with stirring. After that, stirring was performed at 170° C. for 6 hours. Then, the temperature was gradually raised to 230° C. under reduced pressure while continuing stirring and retained for an additional 3 hours. After the mixture became in a viscous state, the mixture was air-cooled, and the reaction was terminated to produce the crystalline polyester 1. The physical properties of the obtained crystalline polyester 1 are shown in Table 4.

TABLE 4

| | Crystalline polyester 1 | Crystalline polyester 2 | Crystalline polyester 3 |
|---|---|---|---|
| Alcohol monomer | 1,9-Nonanediol | 1,12-Dodecanediol | 1,12-Dodecanediol |
| Acid monomer | 1,12-Dodecanedicarboxylic acid | Sebacio acid | Adipio acid |
| Acid value | 2 | 3 | 4 |
| Melting point ° C. | 70 | 80 | 74 |
| Mw | 23000 | 21000 | 32000 |
| Mn | 11000 | 10000 | 14000 |
| Mw/Mn | 2.1 | 2.1 | 2.3 |

### Production Example of Crystalline Polyesters 2 and 3

Crystalline polyesters 2 and 3 were obtained in the same manner as in the production example of the crystalline polyester 1, except that the alcohol monomer and acid monomer used were changed as shown in Table 4. The physical properties of the crystalline polyesters 2 and 3 are shown in Table 4.

### Production Examples 1 to 5 of Silica Fine Particles

While heating and stirring the mixture of methanol, water, and aqueous ammonia, tetramethoxysilane was added dropwise to give a suspension of a silica fine particle. At this time, the heating temperature, stirring rate, and dropping time were adjusted so that the particle diameter of the silica fine particle obtained be the values shown in Table 5. The obtained silica fine particle was allowed to pass through a sieve in a wet manner to remove the coarse particle. The solvent was then removed and dried to give silica fine particles 1 to 5 (sol-gel silica).

### Production Example of Hydrophobically Treated Silica Fine Particle

While heating and stirring the mixture of methanol, water, and aqueous ammonia, tetramethoxysilane was added dropwise to give a suspension of a silica fine particle. At this time, the heating temperature, stirring rate, and dropping time were adjusted so that the particle diameter of the silica fine particle obtained be 20 nm. To the dispersion obtained after the solvent substitution, hexamethyldisilazane was added as a hydrophobic treatment agent at room temperature so that the amount added be 10 parts in relation to 100 parts of the silica fine particle obtained. After that, the mixture was heated to 120° C. to proceed the reaction to hydrophobically treat the silica fine particle surface.

The resulting silica fine particle was passed through a sieve in a wet manner to remove the coarse particle. The solvent was then removed and dried to give a hydrophobically treated silica fine particle (sol-gel silica).

### Production Example of Inorganic Fine Powder 1

100 g of silica fine particle 1 was dispersed in 2 L of water and warmed to 80° C. An aqueous aluminum chloride solution was added to the silica fine particle in an amount of 10% by mass in terms of Al₂O₃ to obtain a mixed liquid. After that, the mixed liquid was adjusted to pH 5.5 with aqueous sodium hydroxide solution, and then retained with stirring for 1 hour to cover the surfaces of the silica fine particle with aluminum hydroxide.

Next, isobutyltrimethoxysilane was added to the mixed liquid in an amount of 60% by mass in relation to the silica fine particle. Then, the mixed liquid was adjusted to pH 7.0 with aqueous sodium hydroxide solution and retained while stirring for 1 hour to give a slurry of inorganic fine powder covered with the silane coupling agent. The resulting slurry was filtered and the residue on the filter medium was washed with water to give a washed cake. The washed cake was dried at 120° C. and pulverized with a media-type pulverizer to prepare inorganic fine powder 1. Obtained physical properties are shown in Table 5.

TABLE 5

| | | Number- | | | | | |
|---|---|---|---|---|---|---|---|
| | | average | | | | | |
| | | particle | | | | | |
| | | diameter of | | | | | |
| | | primary | AlCl3 | ESCA | XRF | | |
| | | particle of | reated | Al/Si | Al/Si | | Al |
| | | substrate | amount/ | value | value | | coverage |
| Inorganic fine powder | Substrate | particle/nm | mass % | X1 | X2 | X1/X2 | ratio/% |
| Inorganic fine powder 1 | Silica fine particle 1 | 15 | 10.0 | 0.21 | 0.18 | 1.15 | 70 |
| Inorganic line powder 2 | Silica fine particle 2 | 5 | 10.0 | 0.16 | 0.19 | 0.84 | 59 |
| Inorganic fine powder 3 | Silica fine particle 3 | 50 | 10.0 | 0.35 | 0.19 | 1.84 | 81 |
| Inorganic fine powder 4 | Silica fine particle 3 | 50 | 10.0 | 0.35 | 0.19 | 1.84 | 81 |
| Inorganic fine powder 5 | Silica fine particle 3 | 50 | 10.0 | 0.35 | 0.19 | 1.84 | 81 |
| Inorganic fine powder 6 | Silica fine particle 4 | 30 | 10.0 | 0.25 | 0.19 | 1.32 | 75 |
| Inorganic fine powder 7 | Silica fine particle 5 | 10 | 10.0 | 0.18 | 0.20 | 0.90 | 64 |
| Inorganic fine powder 8 | Silica fine particle 3 | 50 | 30.0 | 0.48 | 0.25 | 1.92 | 90 |
| Inorganic fine powder 9 | Silica fine particle 3 | 50 | 1.0 | 0.04 | 0.02 | 2.00 | 40 |
| Inorganic fine powder 10 | Silica fine particle 2 | 5 | 3.0 | 0.10 | 0.12 | 0.83 | 42 |
| Inorganic fine powder 11 | Silica fine particle 1 | 15 | 10.0 | 0.10 | 0.18 | 0.56 | 35 |
| Inorganic fine powder 12 | Silica fine particle 1 | 20 | 10.0 | 0.10 | 0.19 | 0.53 | 36 |
| Inorganic fine powder 13 | Silica alumina | 20 | — | 0.08 | 0.20 | 0.40 | 45 |
| Inorganic fine powder 14 | Alumina fine particle | 15 | — | — | — | — | — |
| Inorganic fine powder 15 | Aluminum hydroxide | 50 | — | — | — | — | — |
| | fine particle | | | | | | |

| | | Treated | | |
|---|---|---|---|---|
| | | amount of | Number-average | |
| | | hydrophobic | particle diameter of | |
| | | treating | primary particle of | Volume |
| | Hydrophobic treating | agent/ | inorganic fine | resistance/ |
| Inorganic fine powder | agent species | mass % | powder/nm | Ω · cm |
| Inorganic fine powder 1 | Isobutyltrimethoxysilane | 60 | 18 | 1.0E+12 |
| Inorganic line powder 2 | Isobutyltrimethoxysilane | 60 | 7 | 2.8E+09 |
| Inorganic fine powder 3 | Isobutyltrimethoxysilane | 60 | 50 | 5.0E+12 |
| Inorganic fine powder 4 | Octyltriethoxysilane | 60 | 50 | 6.3E+12 |
| Inorganic fine powder 5 | Decyltriethoxysilane | 60 | 50 | 1.6E+13 |
| Inorganic fine powder 6 | Isobutyltrimethoxysilane | 60 | 31 | 6.5E+12 |
| Inorganic fine powder 7 | Isobutyltrimethoxysilane | 60 | 12 | 8.5E+11 |
| Inorganic fine powder 8 | Isobutyltrimethoxysilane | 60 | 50 | 5.5E+08 |
| Inorganic fine powder 9 | Isobutyltrimethoxysilane | 60 | 50 | 2.0E+13 |
| Inorganic fine powder 10 | Isobutyltrimethoxysilane | 60 | 5 | 1.8E+13 |
| Inorganic fine powder 11 | Isobutyltrimethoxysilane | 60 | 15 | 1.9E+13 |
| Inorganic fine powder 12 | Stearic acid | 60 | 20 | 2.1E+09 |
| Inorganic fine powder 13 | Octyltriethoxysilane | 20 | 20 | 2.1E+10 |
| Inorganic fine powder 14 | Isobutyltrimethoxysilane | 60 | 15 | 3.8E+13 |
| Inorganic fine powder 15 | Isobutyltrimethoxysilane | 60 | 50 | 5.9E+07 |

In the table, the Al coverage ratio indicates the coverage ratio (% by area) of the aluminum element relative to the inorganic fine powder. Also, with regard to the volume resistance of the inorganic fine powder, for example, the expression 1.0 E+12 is intended to mean 1.0×10¹².

### Production Examples 2 to 12 of Inorganic Fine Powder

Inorganic fine powders 2 to 12 were obtained in the same manner as in Production Example 1 of inorganic fine powder, except that the amount of the aqueous aluminum chloride solution added and the hydrophobic treatment agent species were changed as described in Table 5 and the amount of the treatment with the hydrophobic treatment agent was changed so that the coverage ratio of the hydrophobic treatment agent be the values listed in Table 5. The physical properties of inorganic fine powder 2 to 12 are shown in Table 5.

### Production Example of Inorganic Fine Powder 13

To 100 parts by mass of the silica fine particle 1, 945 parts by mass of methanol, 45 parts by mass of 28% aqueous ammonia, and 135 parts by mass of water were added and mixed. The temperature of this solution was adjusted to 35° C., 405 parts by mass of tetramethoxysilane was added dropwise with stirring over 6 hours. The hydrolysis was then performed with continued stirring for 1 hour to prepare a dispersion of a silica fine particle.

In a state where the resulting dispersion was retained at 70° C. under heating, a 5 mol/L aqueous sodium hydroxide solution was added dropwise so that the pH of the dispersion be 8.0. After that, sodium aluminate was then added to the silica fine particle in an amount of 30% by mass as alumina to prepare a slurry containing the alumina-coated silica particle. Then, the pH of the slurry was neutralized to 5.0, retained for 30 minutes with stirring at a temperature of 80° C., and aged. The slurry was distilled under reduced pressure and dried, and then the fine particle was disintegrated to prepare inorganic fine powder 13.

For the inorganic fine powder 13 obtained by the above method, the number-average particle diameter (D50) of the primary particle was measured to find 20 nm.

### Preparation Example of Resin Particle Dispersion of Polyester Resin A-1

Polyester resin A-1:100 parts
Methyl ethyl ketone: 50 parts
Isopropyl alcohol: 20 parts

The vessel was charged with the above methyl ethyl ketone and isopropyl alcohol. After that, the polyester resin A-1 was gradually charged, stirred and completely dissolved to give a solution of the polyester resin A-1. The container containing the polyester resin A-1 solution was set to 65° C., and a 10% aqueous ammonia solution was gradually added dropwise with stirring to a total of 5 parts. Further, 230 parts of ion exchange water were gradually added dropwise at a rate of 10 mL/min to cause a phase inversion emulsification. Further, desolvation was performed in an evaporator under reduced pressure to give a resin particle dispersion of the polyester resin A-1. The volume-average particle diameter of the resin particle included in the obtained resin particle dispersion was 130 nm. In addition, the resin particle solid content was adjusted to 20% using ion exchange water.

### Preparation Example of Resin Particle Dispersion of Polyester Resins A-2 to A-15

Resin particle dispersions of the polyester resins A-2 to A-15 were obtained in the same manner as in the preparation example of the resin particle dispersion of the polyester resin A-1, except that the polyester resins A-2 to A-15 were respectively used instead of the polyester resin A-1.

### Preparation Example of Resin Particle Dispersion of Crystalline Polyester 1

Crystalline polyester 1:100 parts
Methyl ethyl ketone: 50 parts
Isopropyl alcohol: 20 parts

The vessel was charged with the above methyl ethyl ketone and isopropyl alcohol. After that, the above crystalline polyester 1 was gradually charged, stirred, and completely dissolved to give a crystalline polyester 1 solution. The container containing the crystalline polyester 1 solution was set to 40° C., and a 10% aqueous ammonia solution was gradually added dropwise with stirring to a total of 3.5 parts. Further, 230 parts of ion exchange water were gradually added dropwise at a rate of 10 mL/min to cause a phase inversion emulsification. Further, desolvation was performed in an evaporator under reduced pressure to give a resin particle dispersion of the crystalline polyester 1. The volume-average particle diameter of the resin particle included in the obtained resin particle dispersion was 150 nm. In addition, the resin particle solid content was adjusted to 20% using ion exchange water.

### Preparation Example of Resin Particle Dispersion of Crystalline Polyesters 2 and 3

Crystalline resin particle dispersions of the crystalline polyesters 2 and 3 were obtained in the same manner as in the preparation example of the resin particle dispersion of the crystalline polyester 1, except that the crystalline polyesters 2 and 3 were respectively used instead of the crystalline polyester 1.

### Preparation of Colorant Particle Dispersion

Copper phthalocyanine (Pigment Blue 15:3): 45 parts
Ionic surfactant Neogen RK (manufactured by DKS CO. Ltd.): 5 parts
Ion exchange water: 190 parts

The above components were mixed and dispersed using a Homogenizer (ULTRA-TURRAX manufactured by IKA) for 10 minutes. After that, dispersion treatment was performed for 20 minutes at a pressure of 250 MPa using an Ultimizer (counter-collision type wet grinding machine manufactured by Sugino Machine Ltd.) to obtain a colorant particle dispersion. In the obtained colorant particle dispersion, the volume-average particle diameter of the colorant particle was 120 nm, and the solid content was 20%.

### Preparation of Release Agent Particle Dispersion

Release agent (hydrocarbon wax, melting point: 79° C.): 15 parts
Ionic surfactant Neogen RK (manufactured by DKS CO. Ltd.): 2 parts
Ion exchange water: 240 parts

The above components were mixed and heated to 100° C. and dispersed sufficiently in Ultra-Turrax T50 manufactured by IKA. After that, the mixture was warmed to 115° C. with a pressure-discharge type Gaulin homogenizer to perform dispersion treatment for 1 hour to give a release agent particle dispersion with a volume-average particle diameter of 160 nm and a solid content of 20%.

### Production of Toner Particle 1

Resin particle dispersion of polyester resin A-1:900 parts
Resin particle dispersion of crystalline polyester 1:100 parts
Colorant particle dispersion: 50 parts
Release agent particle dispersion: 80 parts

First, each of the materials was put in a round stainless flask and mixed. Subsequently, the mixture was dispersed at 5,000 r/min for 10 minutes using a homogenizer Ultra-Turrax T50 (manufactured by IKA). 1.0% Aqueous nitric acid solution was added to adjust the pH of the mixed liquid to 3.0. After that, the mixed liquid was heated to 58° C. using a stirring blade in a water bath for heating while appropriately adjusting the number of revolutions at which the mixed liquid was stirred.

The volume-average particle diameter of the formed aggregated particle was appropriately checked using Coulter Multisizer III, and when aggregated particle of 6.0 μm was formed, and at that time, the aggregation step was finished.

After that, as a spheroidizing step, a 5% aqueous sodium hydroxide solution was used to adjust the pH of the mixed liquid to 9.0, and the mixed liquid was heated to 92° C. while continuing stirring.

Heating was stopped when a desired surface profile of the toner particle was obtained, and as a cooling step, ice was quickly put so that the cooling rate be 10° C./sec or more to cool the mixture to 40° C. Further, an annealing treatment was performed at 55° C. for 3 hours as an annealing step.

After that, the mixture was cooled to 25° C., filtration and solid-liquid separation were performed, and washing was performed with ion exchange water. After washing, drying using a vacuum drier was performed to obtain a toner particle 1 having a weight-average particle diameter (D4) of 7.1 μm. The physical properties of the toner particle 1 are shown in Tables 6-1 and 6-2.

TABLE 6-1

| | | | Uᵢₛₒ | |
|---|---|---|---|---|
| | | Content Wp | content | |
| | | of polyester | MIPA*Wp | |
| | Polyester | resin A in | in binder | |
| | resin | binder resin | resin | Crystalline |
| | species | (mass %) | (mass %) | polyester |
| Toner | Resin A-1 | 90 | 90 | Crystalline 1 |
| particle 1 | | | | |
| Toner | Resin A-1 | 90 | 90 | Crystalline 2 |
| particle 2 | | | | |
| Toner | Resin A-1 | 90 | 90 | Crystalline 3 |
| particle 3 | | | | |
| Toner | Resin A-2 | 90 | 90 | Crystalline 3 |
| particle 4 | | | | |
| Toner | Resin A-3 | 90 | 90 | Crystalline 3 |
| particle 5 | | | | |
| Toner | Resin A-4 | 90 | 90 | Crystalline 1 |
| particle 6 | | | | |
| Toner | Resin A-5 | 90 | 90 | Crystalline 1 |
| particle 7 | | | | |
| Toner | Resin A-1 | 97 | 97 | Crystalline 1 |
| particle 8 | | | | |
| Toner | Resin A-1 | 85 | 85 | Crystalline 1 |
| particle 9 | | | | |
| Toner | Resin A-1 | 70 | 70 | Crystalline 1 |
| particle 10 | | | | |
| Toner | Resin A-1 | 90 | 90 | Crystalline 1 |
| particle 11 | | | | |
| Toner | Resin A-6 | 90 | 81 | Crystalline 1 |
| particle 12 | | | | |
| Toner | Resin A-7 | 90 | 81 | Crystalline 1 |
| particle 13 | | | | |
| Toner | Resin A-8 | 90 | 81 | Crystalline 1 |
| particle 14 | | | | |
| Toner | Resin A-9 | 90 | 81 | Crystalline 1 |
| particle 15 | | | | |
| Toner | Resin A-1 | 55 | 55 | Crystalline 1 |
| particle 16 | | | | |
| Toner | Resin A-10 | 90 | 54 | Crystalline 1 |
| particle 17 | | | | |
| Toner | Resin A-1 | 65 | 65 | None |
| particle 18 | | | | |
| Toner | Resin A-10 | 100 | 60 | None |
| particle 19 | | | | |
| Toner | Resin A-11 | 100 | 40 | None |
| particle 20 | | | | |
| Toner | Resin A-11 | 90 | 36 | Crystalline 1 |
| particle 21 | | | | |
| Toner | Resin A-12 | 45 | 41 | Crystalline 1 |
| particle 22 | | | | |
| Toner | Resin A-13 | 90 | 27 | Crystalline 1 |
| particle 23 | | | | |
| Toner | Resin A-14 | 90 | 0 | Crystalline 1 |
| particle 24 | | | | |
| Toner | Resin A-15 | 90 | 0 | Crystalline 1 |
| particle 25 | | | | |
| Toner | Styrene acryl | 0 | 0 | None |
| particle 26 | | | | |

TABLE 6-2

| | Content of | Content of | | | |
|---|---|---|---|---|---|
| | crystalline | styrene | Weight- | | |
| | polyester | acrylic | average | | |
| | resin in | resin in | particle | | |
| | binder resin | binder resin | diameter | | |
| | (mass %) | (mass %) | D4 (μm) | Circularity | Production method |
| Toner particle 1 | 10 | 0 | 7.1 | 0.970 | Emulsion aggregation |
| Toner particle 2 | 10 | 0 | 7.0 | 0.970 | Emulsion aggregation |
| Toner particle 3 | 10 | 0 | 7.2 | 0.970 | Emulsion aggregation |
| Toner particle 4 | 10 | 0 | 7.1 | 0.970 | Emulsion aggregation |
| Toner particle 5 | 10 | 0 | 7.1 | 0.970 | Emulsion aggregation |
| Toner particle 6 | 10 | 0 | 7.2 | 0.970 | Emulsion aggregation |
| Toner particle 7 | 10 | 0 | 7.1 | 0.970 | Emulsion aggregation |
| Toner particle 8 | 3 | 0 | 6.8 | 0.978 | Emulsion aggregation |
| Toner particle 9 | 15 | 0 | 6.5 | 0.985 | Emulsion aggregation |
| Toner particle 10 | 10 | 20 | 7.6 | 0.953 | Emulsion aggregation |
| Toner particle 11 | 10 | 0 | 7.1 | 0.940 | Pulverization |
| Toner particle 12 | 10 | 0 | 7.1 | 0.970 | Emulsion aggregation |
| Toner particle 13 | 10 | 0 | 7.0 | 0.970 | Emulsion aggregation |
| Toner particle 14 | 10 | 0 | 7.2 | 0.970 | Emulsion aggregation |
| Toner particle 15 | 10 | 0 | 7.1 | 0.970 | Emulsion aggregation |
| Toner particle 16 | 10 | 35 | 7.1 | 0.970 | Emulsion aggregation |
| Toner particle 17 | 10 | 0 | 7.1 | 0.970 | Emulsion aggregation |
| Toner particle 18 | 0 | 35 | 7.2 | 0.970 | Emulsion aggregation |
| Toner particle 19 | 0 | 0 | 7.0 | 0.970 | Emulsion aggregation |
| Toner particle 20 | 0 | 0 | 7.0 | 0.970 | Emulsion aggregation |
| Toner particle 21 | 10 | 0 | 7.1 | 0.970 | Emulsion aggregation |
| Toner particle 22 | 10 | 45 | 6.5 | 0.980 | Emulsion aggregation |
| Toner particle 23 | 10 | 0 | 7.0 | 0.970 | Emulsion aggregation |
| Toner particle 24 | 10 | 0 | 7.5 | 0.953 | Emulsion aggregation |
| Toner particle 25 | 10 | 0 | 7.3 | 0.965 | Emulsion aggregation |
| Toner particle 26 | 0 | 100 | 7.8 | 0.940 | Pulverization |

### Production Example of Toner Particles 2 to 10 and 12 to 25

Toner particles 2 to 10 and 12 to 25 were obtained in the same manner as in the production example of the toner particle 1, except that the blending and production conditions of the materials used were changed so as to achieve the formulation and physical properties shown in Tables 6-1 and 6-2. The physical properties of the obtained toner particles 2 to 10 and 12 to 25 are shown in Tables 6-1 and 6-2.

### Production Example of Toner Particle 11

### Production of Toner Particle by Pulverization Method

The following materials were thoroughly mixed by an FM mixer (manufactured by Nippon Coke & Engineering Co., Ltd.), and the mixture was melt-kneaded in a two-screw kneader (manufactured by Ikegai Co., Ltd.) set at a temperature of 100° C.
Polyester resin A-1: 90.0 parts
Crystalline polyester resin: 110.0 parts
Hydrocarbon wax, melting point: 79° C.: 8.0 parts
C.I.Pigment Blue 15:35.0 parts

The resulting kneaded product was cooled and coarsely pulverized to 1 mm or less with a hammer mill to obtain a coarsely pulverized product.

Next, a finely pulverized product of about 6.5 μM was obtained using a Turbo Mill manufactured by FREUND-TURBO Corporation from the obtained coarse material, and then the fine coarse powder was further cut using a multi-grade classifier that utilizes the Coanda effect to obtain a toner particle 11.

The weight-average particle diameter (D4) of the toner particle 11 was 7.1 μm, Tg was 58.4° C., and the average circularity was 0.940. The physical properties are shown in Tables 6-1 and 6-2.

### Production Example of Toner Particle 26

Toner particle 26 was obtained in the same manner as in the production example of the toner particle 11, except that the blending and production conditions of the materials used were changed so as to achieve the formulation and physical properties shown in Tables 6-1 and 6-2. The physical properties of the obtained toner 26 are shown in Tables 6-1 and 6-2.

### Production Example of Hydrotalcite Particle 1

A mixed aqueous solution (liquid A) of 1.03 mol/L magnesium chloride and 0.239 mol/L aluminum sulfate, a 0.753 mol/L aqueous sodium carbonate solution (liquid B), and a 3.39 mol/L aqueous sodium hydroxide solution (liquid C) were prepared.

Next, the liquid A, the liquid B, and the liquid C were poured into a reaction vessel using a metering pump at a flow rate so that the ratio of the liquid A:the liquid B be 4.5:1 and keeping the pH value of the reaction solution in the range of 9.3 to 9.6 with the liquid C, and the reaction temperature was set at 40° C. to form a precipitate. After filtration and washing, the precipitate was re-emulsified in ion exchange water to give a raw material hydrotalcite slurry. The hydrotalcite in the resulting hydrotalcite slurry was at a concentration of 5.6% by mass.

Then, the slurry was filtered through a membrane filter with a pore size of 0.5 μm and washed with ion exchange water. The resulting hydrotalcite was dried under vacuum at 40° C. overnight, and after that, a disintegration treatment was performed until the desired particle diameter was obtained to obtain the hydrotalcite particle 1. The number-average particle diameter of the primary particle of the hydrotalcite particle 1 was 400 nm.

### Production Example of Toner 1

The toner particle 1 was externally added. Using an FM mixer (FM10 manufactured by Nippon Coke & Engineering Co., Ltd.), 0.50 parts by mass of the inorganic fine powder 1, 1.00 part by mass of hydrophobically treated silica fine particle, and 0.25 parts by mass of hydrotalcite particle 1 was added in relation to 100 parts by mass of the toner particle 1, followed by external addition under mixing for 5 min at 3000 rpm.

After that, the toner was screened with a mesh with an aperture of 75 μm to obtain the toner 1. The physical properties of the toner 1 are shown in Table 7.

### Production Example of Toners 2 to 40

The toners 2 to 40 were obtained in the same manner as in the production example of the toner 1, except that the kinds of the toner particle and the inorganic fine powder and the content of the inorganic fine powder were changed in the production example of the toner 1. The physical properties of the obtained toners 2 to 40 are shown in Table 7.

Here, the following inorganic fine powders 14 and 15 of the toners 38 and 39 were used, respectively.

Inorganic fine powder 14: alumina fine particle (VPAlu65RK manufactured by Nippon Aerosil Co., Ltd., number average primary particle diameter: 20 nm, treated with isobutylsilane)

Inorganic fine powder 15: aluminum hydroxide fine particle (C-301N manufactured by Sumitomo Chemical Co., Ltd., number-average primary particle diameter: 400 nm, treated with isobutylsilane)

TABLE 7

| | | | Content of | | |
|---|---|---|---|---|---|
| | | | inorganic fine | | |
| | Toner particle | Inorganic fine powder | powder/parts | | |
| Toner | No. | species | by mass | W_{AS}/% by area | W_{AS}/M_{IPA} × Wₚ |
| Toner 1 | Toner particle 1 | Inorganic fine powder 1 | 0.50 | 20.0 | 0.222 |
| Toner 2 | Toner particle 2 | Inorganic fine powder 1 | 0.50 | 20.0 | 0.222 |
| Toner 3 | Toner particle 3 | Inorganic fine powder 1 | 0.50 | 20.0 | 0.222 |
| Toner 4 | Toner particle 4 | Inorganic fine powder 1 | 0.50 | 20.0 | 0.222 |
| Toner 5 | Toner particle 5 | Inorganic fine powder 1 | 0.50 | 20.0 | 0.222 |
| Toner 6 | Toner particle 6 | Inorganic fine powder 1 | 0.50 | 20.0 | 0.222 |
| Toner 7 | Toner particle 7 | Inorganic fine powder 1 | 0.50 | 20.0 | 0.222 |
| Toner 8 | Toner particle 8 | Inorganic fine powder 1 | 0.50 | 20.0 | 0.206 |
| Toner 9 | Toner particle 9 | Inorganic fine powder 1 | 0.50 | 20.0 | 0.235 |
| Toner 10 | Toner particle 10 | Inorganic fine powder 1 | 0.50 | 20.0 | 0.286 |
| Toner 11 | Toner particle 11 | Inorganic fine powder 1 | 0.50 | 20.0 | 0.222 |
| Toner 12 | Toner particle 12 | Inorganic fine powder 1 | 0.50 | 20.0 | 0.247 |
| Toner 13 | Toner particle 13 | Inorganic fine powder 1 | 0.50 | 20.0 | 0.247 |
| Toner 14 | Toner particle 14 | Inorganic fine powder 1 | 0.50 | 20.0 | 0.247 |
| Toner 15 | Toner particle 15 | Inorganic fine powder 1 | 0.50 | 20.0 | 0.247 |
| Toner 16 | Toner particle 16 | Inorganic fine powder 1 | 0.50 | 20.0 | 0.364 |
| Toner 17 | Toner particle 17 | Inorganic fine powder 1 | 0.50 | 20.0 | 0.370 |
| Toner 18 | Toner particle 18 | Inorganic fine powder 1 | 0.50 | 20.0 | 0.308 |
| Toner 19 | Toner particle 19 | Inorganic fine powder 1 | 0.50 | 20.0 | 0.333 |
| Toner 20 | Toner particle 20 | Inorganic fine powder 1 | 0.50 | 20.0 | 0.500 |
| Toner 21 | Toner particle 1 | Inorganic fine powder 2 | 0.30 | 25.0 | 0.278 |
| Toner 22 | Toner particle 1 | Inorganic fine powder 3 | 2.00 | 18.0 | 0.200 |
| Toner 23 | Toner particle 1 | Inorganic fine powder 3 | 5.00 | 50.0 | 0.556 |
| Toner 24 | Toner particle 1 | Inorganic fine powder 4 | 0.50 | 7.0 | 0.078 |
| Toner 25 | Toner particle 1 | Inorganic fine powder 5 | 0.50 | 7.0 | 0.078 |
| Toner 26 | Toner particle 1 | Inorganic fine powder 6 | 0.50 | 25.0 | 0.278 |
| Toner 27 | Toner particle 1 | Inorganic fine powder 7 | 0.80 | 48.0 | 0.533 |
| Toner 28 | Toner particle 1 | Inorganic fine powder 8 | 0.50 | 15.0 | 0.167 |
| Toner 29 | Toner particle 1 | Inorganic fine powder 9 | 0.50 | 15.0 | 0.167 |
| Toner 30 | Toner particle 1 | Inorganic fine powder 10 | 0.50 | 15.0 | 0.167 |
| Toner 31 | Toner particle 21 | Inorganic fine powder 3 | 5.00 | 50.0 | 1.389 |
| Toner 32 | Toner particle 1 | Inorganic fine powder 3 | 0.10 | 3.0 | 0.033 |
| Toner 33 | Toner particle 22 | Inorganic fine powder 1 | 0.50 | 20.0 | 0.444 |
| Toner 34 | Toner particle 23 | Inorganic fine powder 1 | 0.50 | 20.0 | 0.444 |
| Toner 35 | Toner particle 24 | Inorganic fine powder 11 | 1.00 | 25.0 | 0.000 |
| Toner 36 | Toner particle 26 | Inorganic fine powder 12 | 0.80 | 23.0 | 0.000 |
| Toner 37 | Toner particle 25 | Inorganic fine powder 13 | 0.30 | 9.0 | 0.000 |
| Toner 38 | Toner particle 1 | Inorganic fine powder 14 | 1.00 | 20.0 | 0.222 |
| Toner 39 | Toner particle 1 | Inorganic fine powder 15 | 1.00 | 15.0 | 0.167 |
| Toner 40 | Toner particle 1 | None | 0.00 | 0.0 | 0.000 |

In the table, the content of the inorganic fine powder indicates the content of the inorganic fine powder with respect to 100 parts by mass of the toner particle.

### Examples 1 to 32 and Comparative Examples 1 to 8

The following actual machine evaluation was performed using the toners 1 to 40. The evaluation results are shown in Table 8.

A color laser printer, HP LaserJet Enterprise Color M55dn, with a mono-component toner contact development blade cleaning system, and a consumable cartridge for the color laser printer, a cartridge CRG for the HP212X cyan toner, were modified and used.

The main body was modified so that the process speed be 150% and printing tests could be performed only at the cyan station. Also, the cartridge was modified to increase the volume of the toner container so as to contain the following toner filling amount, and the evaluation was performed. In this way, durability evaluation with a longer life could be performed in a main body at a higher speed than before.

### Evaluation 1. Low-Temperature Fixability (Rubbing Density Reduction Rate) of Half-Tone Image Under Low-Temperature and Low-Humidity Environment

The evaluation was performed under a low-temperature and low-humidity environment (temperature: 15° C., relative humidity: 10%), which was a severe environment for evaluating low-temperature fixability. The printer main body and the toner cartridge filled with 550 g of the evaluation toner were left for 24 hours in an environment of 15° C. and 10% RH for the purpose of temperature and humidity adjustment in the evaluation environment. As the evaluation paper, a rough paper, COTTON BOND LIGHT COCKLE (basis weight: 90 g), which was likely to be disadvantageous as evaluation paper in low-temperature fixability due to the unevenness of the paper surface, was used.

The evaluation procedure was to adjust the density of the half-tone image so that the image density be 0.75 to 0.80 at a set temperature of 170° C., with the entire fixing unit at room temperature, and 10 sheets of the image were drawn. The image density at this time was measured using a portable spectrophotometer Exact Advance (X-Rite, Inc.).

After that, images were output at a set temperature of 150° C., and the fixed images were rubbed 10 times on a lens-cleaning paper with a load of 5.4 kPa. From the image density before and after the rubbing, the density drop rate at 150° C. was calculated using the following equation:

$$Density drop rate ( \% ) = ( ( image density before rubbing - image density after rubbing ) \text{} / image density before rubbing ) \times 100$$

Similarly, fixation temperature was increased by 5° C., and density drop rates were calculated up to 200° C.

From the results of the evaluation of the fixation temperature and the density drop rate obtained by a series of operations, quadratic polynomial approximation was performed to obtain a relational expression between the fixation temperature and the density drop rate. Using the relational expression, a temperature at which the density reduction rate was 15% was calculated, and the calculated temperature was set as a fixation temperature indicating a threshold at which low-temperature fixability was good. The lower the fixation temperature is, the better the low-temperature fixability is.

### Evaluation Criteria

A. The fixation temperature is lower than 180° C.
B. The fixation temperature is 180° C. or higher and lower than 190° C.
C. The fixation temperature is 190° C. or higher and lower than to 200° C.
D. The fixation temperature is 200° C. or higher.
   Evaluation 2. Fogging after Double-Sided Durability Under High-Temperature and High-Humidity Environment

A printer main body and a toner cartridge filled with 550 g of evaluation toner were left under a high temperature and high humidity environment (32.5° C., 85% RH) for 24 hours for the purpose of temperature and humidity adjustment in the evaluation environment. After being left as it was, under the same high-temperature and high-humidity environment, double-sided printing was set using a vitality (LTR 75 g/m²) manufactured by XEROX Corp. of a LETTER size, and then durability evaluation was performed by outputting 30,000 sheets (60,000 images) of horizontal line images with a print percentage of 1.0% and a margin of 5 mm, using two double-sided sheets as one job.

After that, the mode was changed to the single-sided printing mode, a paper sheet with a 5 cm×5 cm tag attached to the center of the printing surface of the paper sheet was set in the cassette, then the mode was changed to the single-sided printing mode, and the full-white image was output as the 30,001st sheet (60,001st image) (full-white image 1).

After peeling off the tag of the full white image 1, the reflectance (%) of the portion to which the tag was attached and the reflectance (%) of the portion to which the tag was not attached were measured using a white spectrophotometer TC-6DX (manufactured by Tokyo Denshoku Co., Ltd.), and the difference between both was measured to calculate as fogging (%). Evaluation was then performed on the basis of the following criteria:

### Evaluation Criteria

A. The fogging after the durability evaluation is less than 0.5
B. The fogging after the durability evaluation is 0.5 or more and less than 1.0
C. The fogging after the durability evaluation is 1.0 or more and less than 1.5
D. The fogging after the durability evaluation is 1.5 or more
   Evaluation 3. Density Uniformity and Fading of Solid Images after being Left Under High Temperature and High Humidity Environment

A printer main body and a toner cartridge filled with 550 g of evaluation toner were left under a high temperature and high humidity environment (32.5° C., 85% RH) for 24 hours for the purpose of temperature and humidity adjustment in the evaluation environment. After being left as it was, double-sided printing was set, and then durability evaluation was performed under the same high-temperature and high-humidity environment using a vitality (LTR 75 g/m²) manufactured by XEROX Corp. of a LETTER size by outputting 5,000 sheets (10,000 images) of an image with an all-white image on the first side and a solid image with a 5 mm margin on the second side, with two double-sided sheets as one job.

At the initial stage of the durability evaluation and after 5,000 prints (10,000 images), the printer was left for 72 hours with the power of the printer main body turned off. After that, the printer was powered on, and then changed to the single-sided printing mode to print a single solid image. The obtained solid image was measured at 15 points in total using a portable spectrophotometer Exact Advance (X-Rite, Inc.). The image density was measured at five points at 50 mm intervals in the vertical direction from the leading edge of the paper toward the trailing edge for each of the three columns, i.e., the center column, the column 20 mm from the left edge, and the column 20 mm from the right edge; thus, a total of each 15 points were measured. Then, the density uniformity of the solid image was determined from the difference between the maximum and minimum values of the obtained image density.

Also, it was visually evaluated whether there is a thin portion of density occurring in a band shape on a solid image or not on the basis of the following criteria to determine the image density non-uniformity (fading) in the vertical direction.

### Evaluation Criteria for Density Homogeneity

A. The density difference of the solid image is less than 0.05
B. The density difference of the solid image is 0.05 or more and less than 0.10
C. The density difference of the solid image is 0.10 or more and less than 0.15
D. The density difference of the solid image is 0.15 or more

### Evaluation Criteria for Fading

A: No density-thin occurrence portion is observed at all
B: A slight density-thin occurrence portion is seen
C: A density-thin occurrence portion is seen
D: Significant density differences are seen
   Evaluation 4. Charge Quantity after being Left and Charge Stability after being Left Under High-Temperature and High-Humidity Environment

A printer main body and a toner cartridge filled with 550 g of evaluation toner were left under a high temperature and high humidity environment (32.5° C., 85% RH) for 24 hours for the purpose of temperature and humidity adjustment in the evaluation environment. After being left as it was, double-sided printing was set, and then durability evaluation was performed under the same high-temperature and high-humidity environment using a vitality (LTR 75 g/m²) manufactured by XEROX Corp. of a LETTER size by outputting 5,000 sheets (10,000 images) of an image with an all-white image on the first side and a solid image with a 5 mm margin on the second side, with two double-sided sheets as one job. Charge stability was then evaluated.

At the initial stage and after 5,000 prints (10,000 images) of the above endurance evaluation, the printer was left for 72 hours with the power of the printer main body turned off. After that, the printer was turned on to print a single solid image, and the charge quantity (μC/g) of the toner on the developing image bearing member in the toner cartridge was measured using a blow-off powder charge quantity measuring instrument TB-200 (manufactured by Toshiba Chemical Corp.). The charging performance was evaluated in a high-temperature and high-humidity environment. The larger the absolute value of the charging performance is, the higher the charging performance is, and the smaller the difference in the charge quantity between the initial stage and the post-durable evaluation is, the better the toner is in terms of the charge stability. The evaluation rank of charge quantity and charge stability was determined as follows and evaluated.

### Evaluation Criteria of Charge Quantity

A: The charge quantity is less than −30.0 μC/g
B: The charge quantity is −30.0 μC/g or more and less than −27.5 μC/g
C: The charge quantity is −27.5 μC/g or more and less than −22.5 μC/g
D: The charge quantity is −22.5 μC/g or more

### Charge Stability

The difference between the initial charge quantity and the charge quantity after durability evaluation was judged on the basis of the following criteria:
A: Less than −2.0 μC/g
B: −2.0 μC/g or more and less than −4.0 μC/g
C: −4.0 μC/g or more and less than −6.0 μC/g
D: −6.0 μC/g or more and less than −8.0 μC/g

TABLE 8

| | | Rubbing | | Solid images after | | | |
|---|---|---|---|---|---|---|---|
| | | density | | being left | | | |
| | | reduction | | Density | | Charging | Charging |
| | Toner | rale | Fogging | uniformity | Fading | performance | stability |
| Example 1 | Toner 1 | A | A | A | A | A | A |
| Example 2 | Toner 2 | A | A | A | A | A | A |
| Example 3 | Toner 3 | A | A | A | A | A | A |
| Example 4 | Toner 4 | A | A | A | A | A | A |
| Example 5 | Toner 5 | A | A | A | A | A | A |
| Example 6 | Toner 6 | B | A | A | A | A | A |
| Example 7 | Toner 7 | C | B | A | A | A | A |
| Example 8 | Toner 8 | A | A | A | A | A | A |
| Example 9 | Toner 9 | A | B | A | A | A | A |
| Example 10 | Toner 10 | A | A | A | A | A | A |
| Example 11 | Toner 11 | A | A | B | A | B | A |
| Example 12 | Toner 12 | A | B | A | A | A | A |
| Example 13 | Toner 13 | A | B | A | A | B | A |
| Example 14 | Toner 14 | A | C | A | A | A | A |
| Example 15 | Toner 15 | A | C | A | A | B | A |
| Example 16 | Toner 16 | B | A | A | A | A | A |
| Example 17 | Toner 17 | B | A | A | A | A | A |
| Example 18 | Toner 18 | B | B | A | A | A | A |
| Example 19 | Toner 19 | B | A | B | A | A | A |
| Example 20 | Toner 20 | C | B | B | A | A | A |
| Example 21 | Toner 21 | A | A | A | A | B | B |
| Example 22 | Toner 22 | B | A | B | A | A | A |
| Example 23 | Toner 23 | C | A | B | A | A | B |
| Example 24 | Toner 24 | A | A | B | A | A | A |
| Example 25 | Toner 25 | A | B | B | A | A | A |
| Example 26 | Toner 26 | A | A | A | A | A | A |
| Example 27 | Toner 27 | B | A | A | A | A | A |
| Example 28 | Toner 28 | A | A | B | A | B | A |
| Example 29 | Toner 29 | A | B | C | B | A | B |
| Example 30 | Toner 30 | A | A | B | B | A | B |
| Example 31 | Toner 31 | C | B | B | A | B | B |
| Example 32 | Toner 32 | A | C | C | B | C | C |
| Comparative Example 1 | Toner 33 | D | C | C | C | D | C |
| Comparative Example 2 | Toner 34 | D | D | C | C | D | C |
| Comparative Example 3 | Toner 35 | D | D | C | D | D | D |
| Comparative Example 4 | Toner 36 | A | D | D | D | D | D |
| Comparative Example 5 | Toner 37 | B | D | D | D | D | D |
| Comparative Example 6 | Toner 38 | A | D | D | D | D | D |
| Comparative Example 7 | Toner 39 | D | A | A | A | B | A |
| Comparative Example 8 | Toner 40 | D | A | B | A | A | A |

While the present disclosure has been described with reference to embodiments. it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-129977, filed Aug. 6, 2024, which is hereby incorporated by reference herein in its entirety.

What is claimed is:

1. A toner comprising:
a toner particle comprising a binder resin; and an external additive, wherein
the binder resin comprises a polyester resin A;
when a content of the polyester resin A in the binder resin is taken as Wₚ (mass %), Wₚ is 50 mass % or more;
the polyester resin A is a copolymer of a polycarboxylic acid and a polyol;
the polycarboxylic acid comprises an isophthalic acid;
when a content ratio of a monomer unit Uᵢₛₒ corresponding to the isophthalic acid with respect to all monomer units corresponding to the polycarboxylic acid in the polyester resin A is taken as M_{IPA} (mol %), M_{IPA} is 40 mol % or more;
the external additive comprises an inorganic fine powder; and
the inorganic fine powder comprises a silica fine particle having aluminum hydroxide on a surface thereof.

2. The toner according to claim 1, wherein
M_{IPA} is 90 mol % or more.

3. The toner according to claim 1, wherein
the polyol comprises a bisphenol A ethylene oxide adduct and a bisphenol A propylene oxide adduct, and
a sum of a content ratio of a monomer unit U_{EO} corresponding to the bisphenol A ethylene oxide adduct and a content ratio of a monomer unit U_{PO} corresponding to the bisphenol A propylene oxide adduct with respect to all monomer units corresponding to the polyol in the polyester resin A is 90 mol % or more.

4. The toner according to claim 1, wherein
the polyol comprises a bisphenol A ethylene oxide adduct and a bisphenol A propylene oxide adduct, and
when a sum of a content ratio of a monomer unit U_{EO} corresponding to the bisphenol A ethylene oxide adduct and a content ratio of a monomer unit U_{PO} corresponding to the bisphenol A propylene oxide adduct with respect to all monomer units corresponding to the polyol in the polyester resin A is taken as 100 parts by mole, a content ratio of the monomer unit U_{EO} is 15 to 40 parts by mole.

5. The toner according to claim 1, wherein
when a number average molecular weight is taken as Mₙ and a weight-average molecular weight is taken as M_{w} when tetrahydrofuran-soluble matters of the polyester resin A is measured using gel permeation chromatography, Mₙ is 3000 to 10000, and a value of M_{w}/Mₙ is 2.5 or more.

6. The toner according to claim 1, wherein
the binder resin further comprises a crystalline polyester.

7. The toner according to claim 1, wherein
the toner has an average circularity of 0.950 to 0.980.

8. The toner according to claim 1, wherein
the inorganic fine powder has a number-average particle diameter of primary particle of 5 to 50 nm, and
a content of the inorganic fine powder with respect to 100 parts by mass of the toner particle is 0.1 to 5.0 parts by mass.

9. The toner according to claim 1, wherein
when a value of a ratio (Al/Si) of the number of atoms of Al to Si measured by X-ray photoelectric spectrophotometry of the inorganic fine powder is taken as X₁, and a value of a mass ratio (Al/Si) of Al to Si measured by fluorescent X-ray analysis of the inorganic fine powder is taken as X₂, X₁ and X₂ satisfy Formula (1);
$$0.8 \leq {X}_{1} / {X}_{2} \leq 2 \text{.00} . \qquad ( 1 )$$

10. The toner according to claim 1, wherein
a coverage ratio of aluminum elements relative to the inorganic fine powder, obtained from an element mapping image of aluminum and silicon measured by STEM-EDS mapping of the inorganic fine powder, is 40% to 90% by area.

11. The toner of claim 1, wherein
a coverage ratio W_{AS} (% by area) of the inorganic fine powder on the toner particle surface, calculated from a STEM-EDS mapping image of the toner, is 3.0% to 50.0% by area.

12. The toner of claim 1, wherein
the inorganic fine powder has a powder resistivity of 1.0×10⁸ to 2.0×10¹³ Ω·cm.

13. The toner of claim 1, wherein
when a coverage ratio of the inorganic fine powder on the toner particle surface, calculated from a STEM-EDS mapping image of the toner, is taken as W_{AS} (% by area), W_{AS}, M_{IPA}, and Wₚ satisfy Formula (2);
$$0.03 \leq {W}_{A S} / ( {M}_{I P A} \times {W}_{p} ) \leq 1.39 . \qquad ( 2 )$$
